(19) United States
(12) Patent Application Publication
(10) Pub. No.: US 2013/0316705 A1
(43) Pub. Date: Nov. 28, 2013

(54) METHOD, APPARATUS, AND COMPUTER PROGRAM PRODUCT FOR EFFICIENT NETWORK DISCOVERY

(71) Applicants: Jarkko Sakari KNECKT, Espoo (FI); Janne MARIN, Espoo (FI)

(72) Inventors: Jarkko Sakari KNECKT, Espoo (FI); Janne MARIN, Espoo (FI)

(73) Assignee: Nokia Corporation, Espoo (FI)

(21) Appl. No.: 13/480,752

(22) Filed: May 25, 2012

(51) Int. Cl. H04W 60/00

(52) U.S. Cl. 455/435.1

(57) ABSTRACT

Method, apparatus, and computer program product embodiments of the invention are disclosed to improve the discovery of wireless networks having desired service offerings. In an example embodiment of the invention, a method comprises: broadcasting a wireless generic advertisement service request to a plurality of wireless devices, including an indication that a single response is sufficient; and receiving one or more wireless generic advertisement service responses from only one or more of a plurality of wireless devices in response to the indication that a single response is sufficient.

### FIELD

The embodiments relate to wireless communication, and more particularly to improvements in discovering wireless networks having desired service offerings.

### BACKGROUND

Modern society has adopted, and is becoming reliant upon, wireless communication devices for various purposes, such as connecting users of the wireless communication devices with other users. Wireless communication devices can vary from battery powered handheld devices to stationary household and/or commercial devices utilizing an electrical network as a power source. Due to rapid development of the wireless communication devices, a number of areas capable of enabling entirely new types of communication applications have emerged.

Cellular networks facilitate communication over large geographic areas. These network technologies have commonly been divided by generations, starting in the late 1970s to early 1980s with first generation (1G) analog cellular telephones that provided baseline voice communications, to modern digital cellular telephones. GSM is an example of a widely employed 2G digital cellular network communicating in the 900 MHZ/1.8 GHZ bands in Europe and at 850 MHz and 1.9 GHZ in the United States. While long-range communication networks, like GSM, are a well-accepted means for transmitting and receiving data, due to cost, traffic and legislative concerns, these networks may not be appropriate for all data applications.

Short-range communication technologies provide communication solutions that avoid some of the problems seen in large cellular networks. Bluetooth™ is an example of a short-range wireless technology quickly gaining acceptance in the marketplace. In addition to Bluetooth™ other popular short-range communication technologies include Bluetooth™ Low Energy, IEEE 802.11 wireless local area network (WLAN), Wireless USB (WUSB), Ultra Wide-band (UWB), ZigBee (IEEE 802.15.4, IEEE 802.15.4a), and ultra high frequency radio frequency identification (UHF RFID) technologies. All of these wireless communication technologies have features and advantages that make them appropriate for various applications.

### SUMMARY

Method, apparatus, and computer program product embodiments of the invention are disclosed to improve the discovery of wireless networks having desired service offerings.

In an example embodiment of the invention, a method comprises:
broadcasting a wireless generic advertisement service request to a plurality of wireless devices, including an indication that a single response is sufficient; and
receiving one or more wireless generic advertisement service responses from only one or more of a plurality of wireless devices in response to the indication that a single response is sufficient.

In an example embodiment of the invention, a method comprises:
wherein the generic advertisement service request is one of embedded in a wireless probe request or a separate wireless message.

In an example embodiment of the invention, a method comprises:
wherein the generic advertisement service request includes a medium access control address and a dialog token.

In an example embodiment of the invention, a method comprises:
wherein the generic advertisement service response is one of embedded in a wireless probe response or a separate wireless message.

In an example embodiment of the invention, a method comprises:
receiving a wireless probe response that includes an indication that a separate single wireless generic advertisement service response is transmitted from only one of the plurality of wireless devices in response to the indication that a single response is sufficient.

In an example embodiment of the invention, a method comprises:
receiving a wireless probe response that includes an indication of an estimated time for receipt of a delayed wireless generic advertisement service response.

In an example embodiment of the invention, a method comprises:
receiving multiple wireless generic advertisement service responses that indicate all of the received wireless generic advertisement service responses are duplicates.

In an example embodiment of the invention, a method comprises:
receiving multiple wireless generic advertisement service responses embedded in a wireless probe response that indicates all of the received wireless generic advertisement service responses are duplicates.

In an example embodiment of the invention, a method comprises:
wherein the indication that a single response is sufficient is provided by a mandated requirement of a communications standard under which the wireless generic advertisement service request is broadcast, the communications standard requiring a single response to be sufficient.

In an example embodiment of the invention, a method comprises:
wherein the wireless generic advertisement service request includes response criteria parameters to control devices that respond to the request.

In an example embodiment of the invention, a method comprises:
receiving multiple wireless generic advertisement service responses that indicate a subset of GAS parameters that are needed for link setup that are the same for a plurality of access points.

In an example embodiment of the invention, a method comprises:
receiving a wireless generic advertisement service request to a broadcast address, including an indication that a single response is sufficient;
transmitting the generic advertisement service request to a server, if a single wireless generic advertisement service response is required; and
receiving a generic advertisement service response and instructions from the server to at least transmit the generic advertisement service response with an indication that all generic advertisement service responses are duplicates.

In an example embodiment of the invention, a method comprises:
wherein the instructions from the server are to perform at least one of:
   transmit a probe response with an indication that a separate single wireless generic advertisement service response is transmitted from single access point device;
   transmit a combined wireless probe response and the generic advertisement service response with an indication that all generic advertisement service responses are duplicates; or
   transmit a wireless probe response with an indication of a separate generic advertisement service response, and transmit the separate generic advertisement service response with an indication that all other responding access point devices have the same generic advertisement service response information.

In an example embodiment of the invention, a method comprises:
wherein the wireless generic advertisement service request is a combined Probe Request and GAS Query initiation request;
transmitting to a sender of the wireless generic advertisement service request, a Probe Response in response to the Probe Request;
transmitting the GAS Query initiation request to the server,
receiving a GAS Query response and instructions from the server indicating that the transmitted Probe Response was a first occurring transmission of a Probe Response to the sender of the wireless generic advertisement service request; and
transmitting the GAS Query response to the sender of the wireless generic advertisement service request in response to the instructions indicating that the transmitted Probe Response was a first occurring transmission of a Probe Response.

In an example embodiment of the invention, a method comprises:
wherein the Probe Response includes an indication that a GAS Response will follow.

In an example embodiment of the invention, a method comprises:
wherein the wireless generic advertisement service request is a combined Probe Request and GAS Query initiation request;
transmitting to a sender of the wireless generic advertisement service request, a Probe Response in response to the Probe Request;
transmitting the GAS Query initiation request to the server,
receiving a GAS Query response from the server; and
deleting the GAS Query response if the transmitted Probe Response was not a first occurring transmission of a Probe Response.

In an example embodiment of the invention, a method comprises:
receiving a plurality of generic advertisement service requests from a plurality of access points;
determining a plurality of similar generic advertisement service requests from the received plurality of generic advertisement service requests, based on a common medium access control address and a common dialog token;
transmitting a single network query request corresponding to the plurality of similar generic advertisement service requests, to a generic advertisement service application server;
receiving a generic advertisement service response from the generic advertisement service application server; and
transmitting to each of the plurality of access points the generic advertisement service response and instructions to at least transmit the generic advertisement service response with an indication that all generic advertisement service responses are duplicates.

In an example embodiment of the invention, a method comprises:
wherein the instructions are to perform at least one of:
   transmit a probe response with an indication that a separate single wireless generic advertisement service response is transmitted from single access point device;
   transmit a combined wireless probe response and the generic advertisement service response with an indication that all generic advertisement service responses are duplicates; or
   transmit a wireless probe response with an indication of a separate generic advertisement service response, and transmit the separate generic advertisement service response with an indication that all other responding access point devices have the same generic advertisement service response information.

In an example embodiment of the invention, a method comprises:
wherein the instructions are to transmit a separate single wireless generic advertisement service response by a single access point device that is specified by the mobile wireless device in the wireless generic advertisement service request.

In an example embodiment of the invention, a method comprises:
wherein the single network query request to the generic advertisement service application server, includes information for instructing an access point to set information fields in a generic advertisement service response.

In an example embodiment of the invention, an apparatus comprises:
at least one processor;
at least one memory including computer program code;
the at least one memory and the computer program code configured to, with the at least one processor, cause the device at least to:
broadcast a wireless generic advertisement service request to a plurality of wireless devices, including an indication that a single response is sufficient; and
receive one or more wireless generic advertisement service responses from only one or more of a plurality of wireless devices in response to the indication that a single response is sufficient.

In an example embodiment of the invention, an apparatus comprises:
wherein the generic advertisement service request is one of embedded in a wireless probe request or a separate wireless message.

In an example embodiment of the invention, an apparatus comprises:
wherein the generic advertisement service request includes a medium access control address and a dialog token.

In an example embodiment of the invention, an apparatus comprises:
wherein the generic advertisement service response is one of embedded in a wireless probe response or a separate wireless message.

In an example embodiment of the invention, an apparatus comprises:
the at least one memory and the computer program code configured to, with the at least one processor, cause the device at least to:
receive a wireless probe response that includes an indication that a separate single wireless generic advertisement service response is transmitted from only one of the plurality of wireless devices in response to the indication that a single response is sufficient.

In an example embodiment of the invention, an apparatus comprises:
the at least one memory and the computer program code configured to, with the at least one processor, cause the device at least to:
receive a wireless probe response that includes an indication of an estimated time for receipt of a delayed wireless generic advertisement service response.

In an example embodiment of the invention, an apparatus comprises:
the at least one memory and the computer program code configured to, with the at least one processor, cause the device at least to:
receive multiple wireless generic advertisement service responses that indicate all of the received wireless generic advertisement service responses are duplicates.

In an example embodiment of the invention, an apparatus comprises:
the at least one memory and the computer program code configured to, with the at least one processor, cause the device at least to:
receive multiple wireless generic advertisement service responses embedded in a wireless probe response that indicates all of the received wireless generic advertisement service responses are duplicates.

In an example embodiment of the invention, an apparatus comprises:
at least one processor;
at least one memory including computer program code;
the at least one memory and the computer program code configured to, with the at least one processor, cause the device at least to:
receive a wireless generic advertisement service request to a broadcast address, including an indication that a single response is sufficient;
transmit the generic advertisement service request to a server, if a single wireless generic advertisement service response is required; and
receive a generic advertisement service response and instructions from the server to at least transmit the generic advertisement service response with an indication that all generic advertisement service responses are duplicates.

In an example embodiment of the invention, an apparatus comprises:
wherein the instructions from the server are to perform at least one of:
   transmit a probe response with an indication that a separate single wireless generic advertisement service response is transmitted from single access point device;
   transmit a combined wireless probe response and the generic advertisement service response with an indication that all generic advertisement service responses are duplicates; or
   transmit a wireless probe response with an indication of a separate generic advertisement service response, and transmit the separate generic advertisement service response with an indication that all other responding access point devices have the same generic advertisement service response information.

In an example embodiment of the invention, an apparatus comprises:
the at least one memory and the computer program code configured to, with the at least one processor, cause the device at least to:
buffer the generic advertisement service responses and instructions from the server, in a cache memory of the apparatus; and
access the cache memory and transmit the buffered generic advertisement service responses to at least one access point, without transmitting a query to the server, if there is a delay in receiving a response from the server for the generic advertisement service request.

In an example embodiment of the invention, an apparatus comprises:
at least one processor;
at least one memory including computer program code;
the at least one memory and the computer program code configured to, with the at least one processor, cause the device at least to:
receive a plurality of generic advertisement service requests from a plurality of access points;
determine a plurality of similar generic advertisement service requests from the received plurality of generic advertisement service requests, based on a common medium access control address and a common dialog token;
transmit a single network query request corresponding to the plurality of similar generic advertisement service requests, to a generic advertisement service application server;
receive a generic advertisement service response from the generic advertisement service application server; and
transmit to each of the plurality of access points the generic advertisement service response and instructions to at least transmit the generic advertisement service response with an indication that all generic advertisement service responses are duplicates.

In an example embodiment of the invention, an apparatus comprises:
wherein the instructions are to perform at least one of:
   transmit a probe response with an indication that a separate single wireless generic advertisement service response is transmitted from single access point device;
   transmit a combined wireless probe response and the generic advertisement service response with an indication that all generic advertisement service responses are duplicates; or
   transmit a wireless probe response with an indication of a separate generic advertisement service response, and transmit the separate generic advertisement service response with an indication that all other responding access point devices have the same generic advertisement service response information.

In an example embodiment of the invention, an apparatus comprises:
wherein the apparatus is an access point in a same network as the plurality of access points.

In an example embodiment of the invention, a computer program product comprising computer executable program code recorded on a computer readable, non-transitory storage medium, the computer executable program code, when executed by a computer processor, comprising:
code for broadcasting a wireless generic advertisement service request to a plurality of wireless devices, including an indication that a single response is sufficient; and
receiving one or more wireless generic advertisement service responses from only one or more of a plurality of wireless devices in response to the indication that a single response is sufficient.

In an example embodiment of the invention, a computer program product comprising computer executable program code recorded on a computer readable, non-transitory storage medium, the computer executable program code, when executed by a computer processor, comprising:
code for receiving a wireless generic advertisement service request to a broadcast address, including an indication that a single response is sufficient;
code for transmitting the generic advertisement service request to a server, if a single wireless generic advertisement service response is required; and
code for receiving a generic advertisement service response and instructions from the server to at least transmit the generic advertisement service response with an indication that all generic advertisement service responses are duplicates.

In an example embodiment of the invention, a computer program product comprising computer executable program code recorded on a computer readable, non-transitory storage medium, the computer executable program code, when executed by a computer processor, comprising:
code for receiving a plurality of generic advertisement service requests from a plurality of access points;
code for determining a plurality of similar generic advertisement service requests from the received plurality of generic advertisement service requests, based on a common medium access control address and a common dialog token;
code for transmitting a single network query request corresponding to the plurality of similar generic advertisement service requests, to a generic advertisement service application server;
code for receiving a generic advertisement service response from the generic advertisement service application server; and
code for transmitting to each of the plurality of access points the generic advertisement service response and instructions to at least transmit the generic advertisement service response with an indication that all generic advertisement service responses are duplicates.

In this manner, embodiments of the invention improve the discovery of wireless networks having desired service offerings.

### DESCRIPTION OF THE FIGURES

FIG. 1A illustrates an example network architecture comprising a mobile wireless device broadcasting a generic advertising service (GAS) query request, an extended service set (ESS) comprising two access point (AP) devices in two respective infrastructure basic service set (BSS) networks connected to a GAS query combination server (GQCS), the GAS query request including an indication that a single response from the ESS is enough, a medium access control (MAC) address and a Dialog Token, the GAS query combination server configured to determine the similarity of two GAS query requests forwarded from the two access point devices based on the MAC address and Dialog Token, the GAS query combination server further configured to transmit a single Access Network Query Protocol (ANQP) request corresponding to the two similar GAS Query requests, to a GAS application server, in accordance with an example embodiment of the invention.

FIG. 1B illustrates the example network architecture of FIG. 1A, wherein the GAS query combination server (GQCS) is configured to receive an Access Network Query Protocol (ANQP) response for the ANQP request from the GAS application server, the GAS query combination server further configured to transmit to each of the plurality of APs, instructions to send at least one of: 1) a probe response with indication that a separate single GAS Query response is transmitted from single AP, 2) a combined probe response and GAS Query response with an indication that all GAS Query results from the extended service set (ESS) are duplicates, and/or 3) a probe response with indication of separate GAS Query response, and the separate GAS Query response with indication that also all other APs in the ESS have the same GAS Query response information, in accordance with an example embodiment of the invention.

FIG. 1C illustrates the example network architecture of FIG. 1A, wherein the functions of the GAS query combination server (GQCS) are incorporated as part of an access point device in the same extended service set (ESS) as the two access point devices in the two respective infrastructure BSS networks, the GAS query combination server configured to determine the similarity of two GAS query requests forwarded from the two access point devices based on the MAC address and Dialog Token, the GAS query combination server further configured to transmit a single Access Network Query Protocol (ANQP) request corresponding to the two similar GAS Query requests, to the GAS application server, in accordance with an example embodiment of the invention.

FIG. 2A illustrates an example wireless network and functional block diagram of the mobile wireless device and the access point, with the mobile wireless device groupcasting a combination probe request and generic advertisement service (GAS) request frame, including an indication that a single response from the extended service set (ESS) is enough, in accordance with an example embodiment of the invention.

FIG. 2B illustrates the example wireless network and functional block diagram of FIG. 2A, of the mobile wireless device and the access point, with the access point transmitting a combination probe response and generic advertisement service (GAS) response frame, with an indication that all GAS Query results from the extended service set (ESS) are duplicates, in accordance with an example embodiment of the invention.

FIG. 2C illustrates the example wireless network and functional block diagram of FIG. 2A, wherein the functions of the GAS query combination server (GQCS) are incorporated as part of an access point device, in accordance with an example embodiment of the invention.

FIG. 2D illustrates the example wireless network and functional block diagram of the GAS query combination server (GQCS), in accordance with an example embodiment of the invention.

FIG. 3A illustrates an example combination probe request and Generic Advertisement Service (GAS) request frame of an IEEE 802.11 MAC management frame, in accordance with an example embodiment of the invention.

FIG. 3B illustrates an example frame body format of the combination probe request and Generic Advertisement Service (GAS) Request Frame, in accordance with an example embodiment of the invention.

FIG. 3C illustrates an example frame body format of the combination probe response and Generic Advertisement Service (GAS) Response Frame, in accordance with an example embodiment of the invention.

FIG. 3D illustrates an example Access Network Query Protocol (ANQP) Information ID Definitions, in accordance with an example embodiment of the invention.

FIG. 4 is an example flow diagram of operational steps of an example embodiment of the procedure performed in the mobile wireless device, according to an embodiment of the present invention.

FIG. 5 is an example flow diagram of operational steps of an example embodiment of the procedure performed in the access point device, according to an embodiment of the present invention.

FIG. 6 is an example flow diagram of operational steps of an example embodiment of the procedure performed in the GAS query combination server (GQCS), according to an embodiment of the present invention.

FIG. 7 illustrates an example embodiment of the invention, wherein examples of removable storage media are shown, in accordance with at least one embodiment of the present invention.

### DISCUSSION OF EXAMPLE EMBODIMENTS OF THE INVENTION

This section is organized into the following topics:
A. WLAN Communication Technology
   1. IEEE 802.11 MAC Frames and Information Elements
   2. IEEE 802.11 Beacon, Probe Request and Response
   3. Generic Advertisement Service (GAS)
   4. Wi-Fi Direct—Software Access Points
B. Efficient Network Discovery

A. Wlan Communication Technology

An example wireless network, such as a Wireless Local Area Network (WLAN) may be organized as an independent basic service set (IBSS), mesh basic service set (MBSS) or an infrastructure basic service set (BSS). Wireless devices in an independent basic service set (IBSS) communicate directly with one another and there is no access point (AP) in the IBSS. A mesh basic service set (MBSS) consists of autonomous wireless devices that establish peer-to-peer wireless links that provide means for multi-hop communication. An infrastructure basic service set (BSS) includes a wireless access point that may be connected to one or more servers and peripheral devices by a wired backbone connection. In an infrastructure BSS, the access point is a central hub to which mobile wireless devices are wirelessly connected. The mobile wireless devices typically do not communicate directly with one another, but communicate indirectly through the access point. An access point may be connected to other access points by a wired backbone connection in an extended service set (ESS). Mobile wireless devices may roam from one wireless connection with one access point to a second wireless connection with a second access point in the ESS, and still be linked to the first access point in the ESS via the wired backbone connection.

The IEEE 802.11 standard specifies methods and techniques of wireless local area network (WLAN) operation. Examples include the IEEE 802.11b and 802.11g wireless local area network specifications, which have been a staple technology for traditional WLAN applications in the 2.4 GHz ISM band. The various amendments to the IEEE 802.11 standard were consolidated for IEEE 802.11a, b, d, e, g, h, i, j, k, n, r, s, u, v, and z protocols, into the base standard IEEE 802.11-2012, Wireless Medium Access Control (MAC) and Physical Layer (PHY) Specifications, February 2012 (incorporated herein by reference). Since then, emerging broadband applications have stimulated interest in developing very high-speed wireless networks for short range communication, for example, the IEEE 802.11n, the planned IEEE 802.11 ac, and the planned IEEE 802.11ad WLAN specifications that are to provide a very high throughput in higher frequency bands. Applications of these IEEE 802.11 standards include products such as consumer electronics, telephones, personal computers, and access points for both for home and office.

According to an example embodiment, wireless local area networks (WLANs) typically operate in unlicensed bands. IEEE 802.11b and 802.11g WLANs have been a staple technology for traditional WLAN applications in the 2.4 GHz ISM band and have a nominal range of 100 meters. The IEEE 802.11ah WLAN standard is being developed for operation in the 900 MHz ISM band and will have a greater range and lower obstruction losses due to its longer wavelength.

1. IEEE 802.11 MAC Frames and Information Elements

There are three major types of medium access control (MAC) frames in the IEEE 802.11 protocol: the management frame, the control frame, and the data frame. Management frames provide management services. Data frames carry payload data. Control frames assist in the delivery of data frames. Each of these types of MAC frame consists of a MAC header, a frame body, and a frame check sequence (FCS). The header contains control information used for defining the type of 802.11 MAC frame and providing information necessary to process the MAC frame. The frame body contains the data or information included in either management type or data type frames. The frame check sequence is a value representing a cyclic redundancy check (CRC) over all the fields of the MAC header and the frame body field.

Management frames are used to provide management services that may be specified by variable-length fields called information elements included in the MAC frame body. An information element includes three fields: its function is identified by an element ID field, its size is provided by a length field, and the information to deliver to the recipient is provided in a variable-length information field.

2. IEEE 802.11 Beacon, Probe Request and Response

a. Beacon

The beacon frame is a management frame that is transmitted periodically to allow wireless devices to locate and identify a network. The beacon frame includes the fields: timestamp, beacon interval, and capability information. The timestamp contains the value of the device's synchronization timer at the time that the frame was transmitted. The capability information field is a 16-bit field that identifies the capabilities of the device. The information elements in a beacon frame are the service set identifier (SSID), the supported rates, one or more physical parameter sets, an optional contention-free parameter set, and an optional traffic indication map.

i. Infrastructure BSS Networks with an Access Point

In an infrastructure BSS networks with an Access Point, beacon frames are used for enabling wireless devices to establish and maintain orderly communications. The beacon frames are transmitted by the Access Points at regular intervals and include a frame header and a body with various information, including a SSID identifying the name of a specific WLAN and a beacon interval specifying the intended time interval between two beacon transmissions. One purpose of the beacon frames is to inform the wireless devices about the presence of an Access Point in the area. The access point in an infrastructure BSS IEEE 802.11 WLAN network, may be a central hub that relays all communication between the mobile wireless devices (STAs) in an infrastructure BSS. If a STA in an infrastructure BSS wishes to communicate a frame of data to a second STA, the communication may take two hops. First, the originating STA may transfer the frame to the AP. Second, the AP may transfer the frame to the second STA. In an infrastructure BSS, the AP may transmit beacons or respond to probes received from STAs. After a possible authentication of a STA that may be conducted by the AP, an association may occur between the AP and a STA enabling data traffic to be exchanged with the AP. The Access Point in an Infrastructure BSS may bridge traffic out of the BSS onto a distribution network. STAs that are members of the BSS may exchange packets with the AP.

ii. Ad Hoc IBSS Networks

The first ad hoc wireless device to become active establishes an IBSS and starts sending beacons to inform the other wireless devices about the presence of an ad hoc network in the area. Other ad hoc wireless devices may join the network after receiving a beacon and accepting the IBSS parameters, such as the beacon interval, found in the beacon frame.

Each wireless device that joins the ad hoc network may send a beacon periodically if it doesn't hear a beacon from another device within a short random delay period after the beacon is supposed to be sent. If a wireless device doesn't hear a beacon within the random delay period, then the wireless device assumes that no other wireless devices are active in the ad hoc network and a beacon needs to be sent.

A beacon signal is periodically transmitted from the ad hoc network. The beacon frame is transmitted periodically and includes the address of the sending device.

b. Probe Request

The probe request frame is a management frame that is transmitted by a wireless device attempting to quickly locate a wireless local area network (LAN). It may be used to locate independent basic service sets (IBSSs), infrastructure basic service sets (BSSs) or mesh basic service sets (MBSSs) only or any of them. It may be used to locate a wireless LAN with a particular SSID or to locate any wireless LAN. The probe request frame may contain a service attribute request.

For active scans, the wireless device either broadcasts or unicasts a probe request on the channel it is scanning. It may set the SSID in the probe request to a wildcard SSID or to a specific SSID value. It may set the BSSID in the probe request a wildcard BSSID or to a specific BSSID value. With these options the wireless device can look for any SSID or BSSID, any representative of a specific SSID or a specific BSSID. The wireless device will add any received beacons or probe responses to a cached BSSID scan list. For passive scans, the wireless device does not send a probe request, but instead, listens on a channel for a period of time and adds any received beacons or probe responses to its cached BSSID scan list. The wireless device may scan both infrastructure and ad hoc networks, regardless of the current setting of its network mode. The wireless device may use either the active or passive scanning methods, or a combination of both scanning methods. The wireless device performs the scan across all the frequency channels and bands that it supports.

i. Infrastructure BSS Networks with an Access Point

The wireless device may transmit a probe request and receive a probe response from the access point in the BSS. The probe request is transmitted by a wireless device to obtain information from another station or access point. For example, a wireless device may transmit a probe request to determine whether a certain access point is available. In the infrastructure BSS, only the AP responds to probe requests. The probe response sent back by the AP contains a timestamp, beacon interval, and capability information. It also includes the SSID of the BSS, supported rates, and PHY parameters. The wireless device STA may learn that the access point AP will accept the STA's credentials.

Exemplary rules applied by the scanning wireless device (i.e. scanner) and the APs with active scanning are as follows:
1) Scanner (for each channel to be scanned):
   a. ProbeTimer is set before transmission of probe request. During the probe timer the scanning device tries to obtain a transmission from the media in order to obtain NAV information. If transmission is received or the probe timer expires, the device may transmit a probe request.
   b. Transmit a probe request frame (or multiple of thereof) with the SSID and the BSSID fields set as per the scan command;
   c. Reset ProbeTimer to zero and start it upon the probe request transmission;
   d. If nothing is detected (any signal with high enough energy) on the channel before the ProbeTimer reaches MinChannelTime (a.k.a. Min_Probe_Response_Time), then go to scan the next channel (if any), else when the ProbeTimer reaches MaxChannelTime (i.e., Max_Probe_Response_Time), process all received probe responses and go to scan the next channel (if any).
2) APs:
   a. An AP shall respond with a probe response only if:
      i. The Address 1 field in the probe request frame is the broadcast address or the specific MAC address of the AP; and
      ii. The SSID in the probe request is the wildcard SSID, the SSID in the probe request is the specific SSID of the AP, or the specific SSID of the AP is included in the SSID list element of the probe request, or the Address 3 field in the probe request is the wildcard BSSID or the BSSID of the AP.
   b. Some further conditions may be set as well for the generation of a probe response.

In general, the probe request transmitter specifies the conditions that wireless devices need to meet in order to respond to with a probe response. All wireless devices that fulfill the condition try to send a probe response frame. The active scanning mechanism defines the signaling.

ii. Ad Hoc IBSS Networks

The effect of receiving a probe request is to cause the wireless device to respond with a probe response if the conditions indicated in the probe request are met. When a wireless device arrives within the communication range of any member of an ad hoc network, its probe request frame inquiry signals are answered by a member of the ad hoc network detecting the inquiry. A device in an ad hoc network that broadcasted the latest beacon in the network responds to the probe request frame inquiry signals with a probe response containing the address of the responding device. The probe response frame also includes the timestamp, beacon interval, capability information, information elements of the SSID, supported rates, one or more physical parameter sets, the optional contention-free parameter set, and the optional ad hoc network parameter set.

Once a device has performed an inquiry that results in one or more ad hoc network descriptions, the device may choose to join one of the ad hoc networks. The joining process may be a purely local process that occurs entirely internal to the wireless device. There may be no indication to the outside world that a device has joined a particular ad hoc network. Joining an ad hoc network may require that all of the wireless device's MAC and physical parameters be synchronized or compatible with the desired ad hoc network. To do this, the device may update its timer with the value of the timer from the ad hoc network description, modified by adding the time elapsed since the description was acquired. This will synchronize the timer to the ad hoc network. The BSSID of the ad hoc network may be adopted, as well as the parameters in the capability information field. Once this process is complete, the wireless device has joined the ad hoc network and is ready to begin communicating with the devices in the ad hoc network.

c. Probe Response

The probe response sent back by a wireless device that met the conditions set by the received probe request may contain a timestamp, beacon interval, and capability information. It may also include the SSID of the BSS, supported rates, and PHY parameters.

According to an example embodiment, standard spacing intervals are defined in the IEEE 802.11 specification, which delay a station's access to the medium, between the end of the last symbol of the previous frame and the beginning of the first symbol of the next frame. The short interframe space (SIFS), may allow acknowledgement (ACK) frames and clear to send (CTS) frames to have access to the medium before others. The longer duration distributed coordination function (DCF) interframe space (IFS) or DCF Interframe Space (DIFS) interval may be used for transmitting data frames and management frames.

According to an example embodiment, after the channel has been released, IEEE 802.11 and before a probe response is transmitted, wireless devices may normally employ a spectrum sensing capability during the SIFS interval or DIFS interval, to detect whether the channel is busy. A carrier sensing scheme may be used wherein a node wishing to transmit a probe response has to first listen to the channel for a predetermined amount of time to determine whether or not another node is transmitting on the channel within the wireless range. If the channel is sensed to be idle, then the node may be permitted to begin the transmission process. If the channel is sensed to be busy, then the node may delay its transmission of a probe response for a random period of time called the backoff interval. In the DCF protocol used in IEEE 802.11 networks, the stations, on sensing a channel idle for DIFS interval, may enter the backoff phase with a random value between 0 and a maximum value CW. (CW is adjusted between CW_{Min} and CW_{Max} based on transmission failures/successes.) The backoff counter may be decremented from this selected value as long as the channel is sensed idle for a predetermined time interval. After every received frame one may however wait for a DIFS before sensing the channel status and resuming backoff counter update.

3. Generic Advertisement Service (GAS)

IEEE 802.11u-2011 is an amendment to the IEEE 802.11-2007 base standard published as IEEE 802.11u-2011, Wireless LAN Medium Access Control (MAC) and Physical Layer (PHY) Specifications, Amendment 9: Interworking with External Networks, Feb. 25, 2011 (incorporated herein by reference). IEEE 802.11u-2011 adds features to improve interworking with external networks. IEEE 802.11u-2011 amendment establishes MAC and physical layer PHY protocols for an interworking service to permit a wireless device to exchange information with an external network, to enable the selection of networks to connect to, and to enable access to emergency services. A GAS is specified in the IEEE 802.11u amendment to enable mobile wireless devices or STAs to discover the availability of information related to desired network services. For example, the GAS enables discovery of information about services provided in an infrastructure basic service set, information about local access services, information from available Subscription Service Providers (SSP) and/or Subscription Service Provider Networks (SSPNs) or other external networks. GAS enables a wireless device to transmit a generic advertisement service initial request frame to request information about network services from access points and it enables an access point to use a generic container, a GAS initial response frame, to advertise information about network services over an IEEE 802.11 network. The GAS protocol has been proposed to be updated to operate with broadcast request and response messages. Public action frames are used to transport the GAS initial request frame and the GAS initial response frame.

4. Wi-Fi Direct

The Wi-Fi Alliance has developed a Wi-Fi Peer-to-Peer technology named Wi-Fi Direct™ that is specified in the Wi-Fi Alliance Peer-to-Peer Specification, October 2010 (incorporated herein by reference). Wi-Fi Direct is also referred to herein as Peer-to-Peer (P2P) or Device-to-Device (D2D). Wi-Fi Direct enables IEEE 802.11a, g, or n devices to connect to one another, peer-to-peer, without prior setup or the need for wireless access points. Devices that support Wi-Fi Direct may discover one another and advertise available services. Wi-Fi Direct devices support typical Wi-Fi ranges and the same data rates as can be achieved with an 802.11a, g, or n infrastructure connection. When a device enters the range of the Wi-Fi Direct device, it may connect to it using the specified protocol.

Wi-Fi Direct enables wireless devices that support Wi-Fi Direct, to connect to one another, point-to-point, without joining an infrastructure network. Wireless devices that support the specification will be able to discover one another and advertise available services. Wi-Fi Direct devices will support typical Wi-Fi ranges and the same data rates as can be achieved with an infrastructure connection. Wi-Fi Direct provides point-to-point connections for networks by embedding a software access point into any Wi-Fi Direct devices.

Wi-Fi Direct-certified devices may create direct connections between each other without requiring the presence of a traditional Wi-Fi infrastructure network of an access point or router. Wi-Fi Direct Device Discovery and Service Discovery features allow users to identify available devices and services before establishing a connection, for example, discovering which Wi-Fi Direct devices have a printer. Wi-Fi Direct devices may use Wi-Fi Protected Setup to create connections between devices.

A Wi-Fi Direct device is capable of a peer-to-peer connection and may support either an infrastructure network of an access point or router or a peer-to-peer connection. Wi-Fi Direct devices may join infrastructure networks as stations (STAs). Wi-Fi Direct devices may connect by forming groups in a one-to-one or one-to-many topology. The group functions in a manner similar to an infrastructure basic service set. A single Wi-Fi Direct device will be the group owner that manages the group, including controlling which devices are allowed to join and when the group is started or terminated. The group owner is responsible for responding to probe requests in a similar manner as an AP of an infrastructure BSS. The group owner will appear as an access point to legacy client devices. A significant difference between a group owner and an access point is that it is optional for the group owner to route and forward traffic between clients associated to it.

Wi-Fi Direct devices include Wi-Fi Protected Setup Internal Registrar functionality. A Wi-Fi Direct device may be a group owner of a group and may be able to negotiate which device adopts this role when forming a group with another Wi-Fi Direct device. A group may include both Wi-Fi Direct devices and legacy devices (i.e., that are not compliant with the Wi-Fi Alliance Peer-to-Peer Specification). Legacy devices may only function as clients within a group.

Wi-Fi Direct devices may support discovery mechanisms. Device discovery is used to identify other Wi-Fi Direct devices and establish a connection by using a scan similar to that used to discover infrastructure access points. If the target is not already part of a group, a new group may be formed. If the target is already part of a group, the searching Wi-Fi Direct device may attempt to join the existing group. Wi-Fi Protected Setup may be used to obtain credentials from the group owner and authenticate the searching Wi-Fi Direct device. Wi-Fi Direct devices may include service discovery that enables the advertisement of services supported by higher layer applications to other Wi-Fi Direct devices. Service discovery may be performed at any time (e.g. even before a connection is formed) with any other discovered Wi-Fi Direct device.

A Group may be created by a single Wi-Fi Direct device. When forming a connection between two Wi-Fi Direct devices, a group may be formed automatically and the devices may negotiate to determine which device is the group owner. The group owner may decide if this is a temporary (single instance) or persistent (multiple, recurring use) group. After a group is formed, a Wi-Fi Direct device may invite another Wi-Fi Direct device to join the group. The decision of whether or not to accept an invitation may be left to the invited Wi-Fi Direct device.

B. Efficient Network Discovery

The IEEE 802.11 wireless LAN standard defines two discovery operations:
Access point (AP) discovery is based on the probe request and probe response exchange that ensures an access point is available and has the capabilities and support needed for a desired operation by the scanning mobile wireless device (STA). The access point discovery is typically active scanning performed by transmissions of Probe Request and Probe Response frames. A probe request may be generally seen as a physical access request to one or more wireless devices. The probe request and response exchange is a low-delay discovery operation, and it may be used also to discover information or operating parameters for the air interface. In home area networks and in case of independent access points, the probe request and response exchange may be enough to setup an initial connection between the wireless device and the access point.
Network discovery is based on the generic advertising service (GAS) query request and GAS query response exchange that ensures access to a network with the desired characteristics is available to the scanning mobile wireless device (STA). Hence, a GAS query request may be generally seen as a network service request as opposed to an initial access request like a probe request. The GAS query protocol enables more comprehensive information discovery and allows the requesting STA to initiate queries to Internet and beyond the responding STA. Network parameters are queried by an access point from a GAS application server external that is to the basic service set (BSS) of the access point. The queries are initiated and the response is reported through GAS Query response frame transmitted by the access point and GAS Query response frame received by the STA. GAS Query requests may be broadcast by the STA to a plurality of access points connected to a BSS network and each receiving access point may be required to respond to the STA with a GAS query response. An access point may deliver a received GAS request to the GAS application server, which may determine whether the service request can be fulfilled by the network. Examples of such services include discovery of larger roaming consortiums and coordinated use of authentication services, or discovery of various network configuration parameters like IP address configuration.

In accordance with an example embodiment of the invention, duplicates of a GAS query response transmitted by multiple access points that are responding to a single GAS query request from the STA, may be controlled and limited, thereby enabling the STA to focus on a single, common response and thus minimize its scanning time.

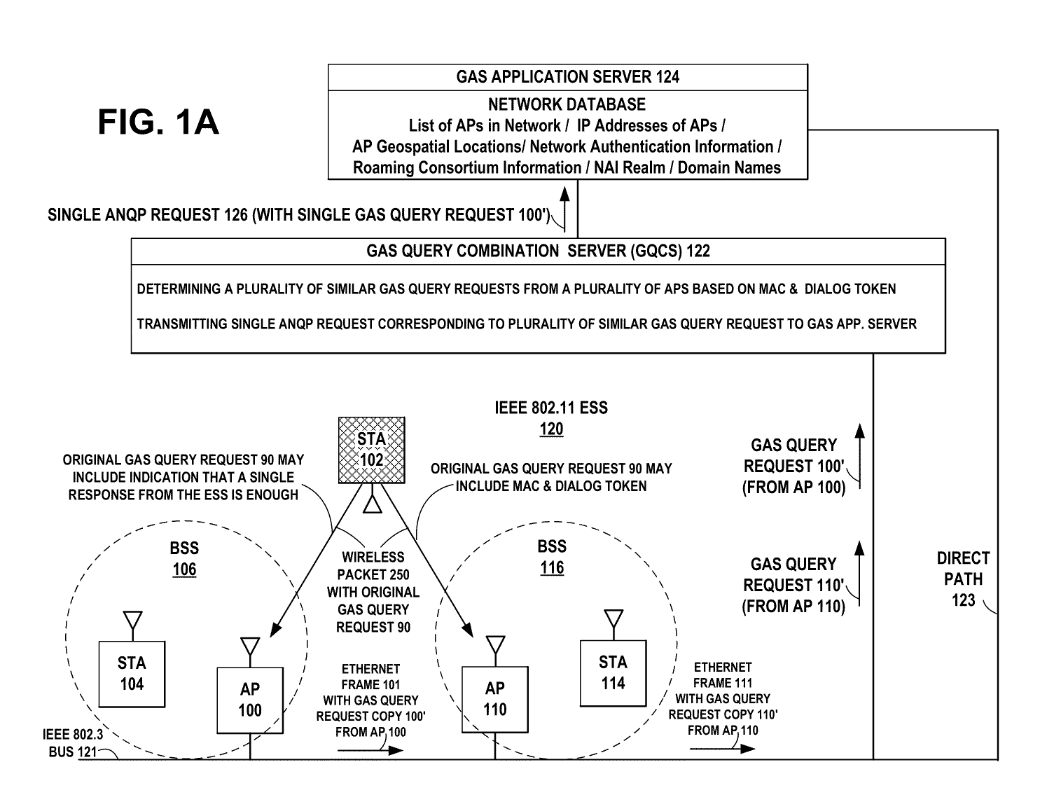

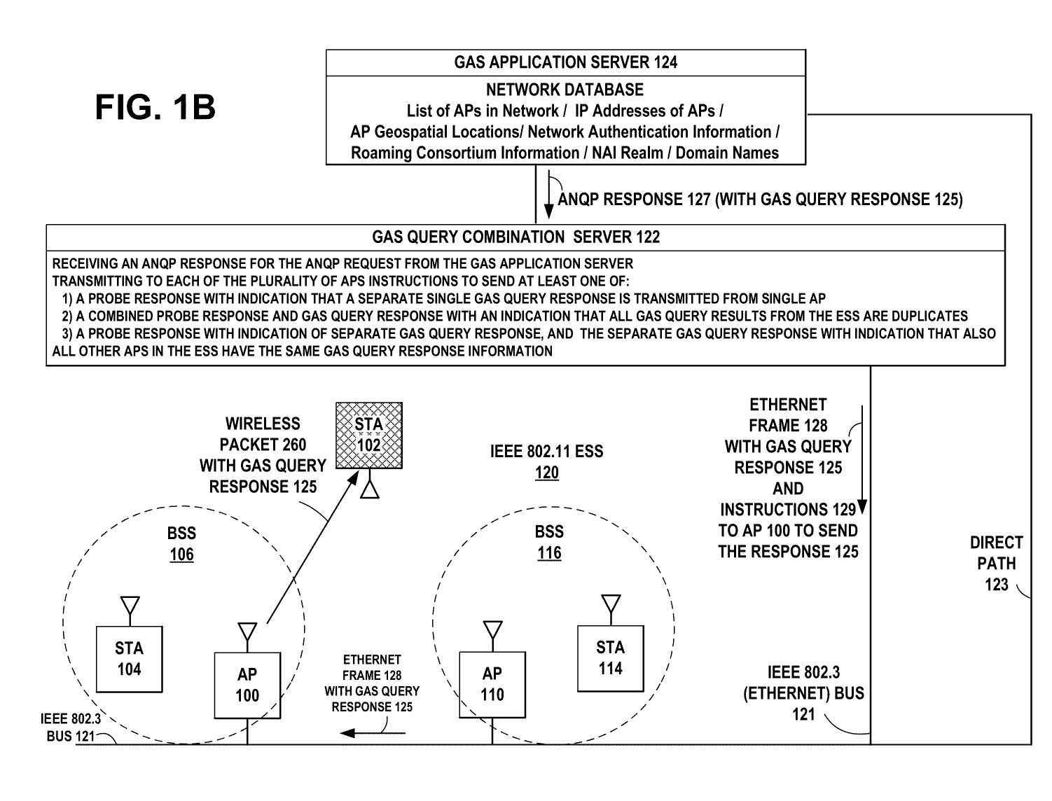

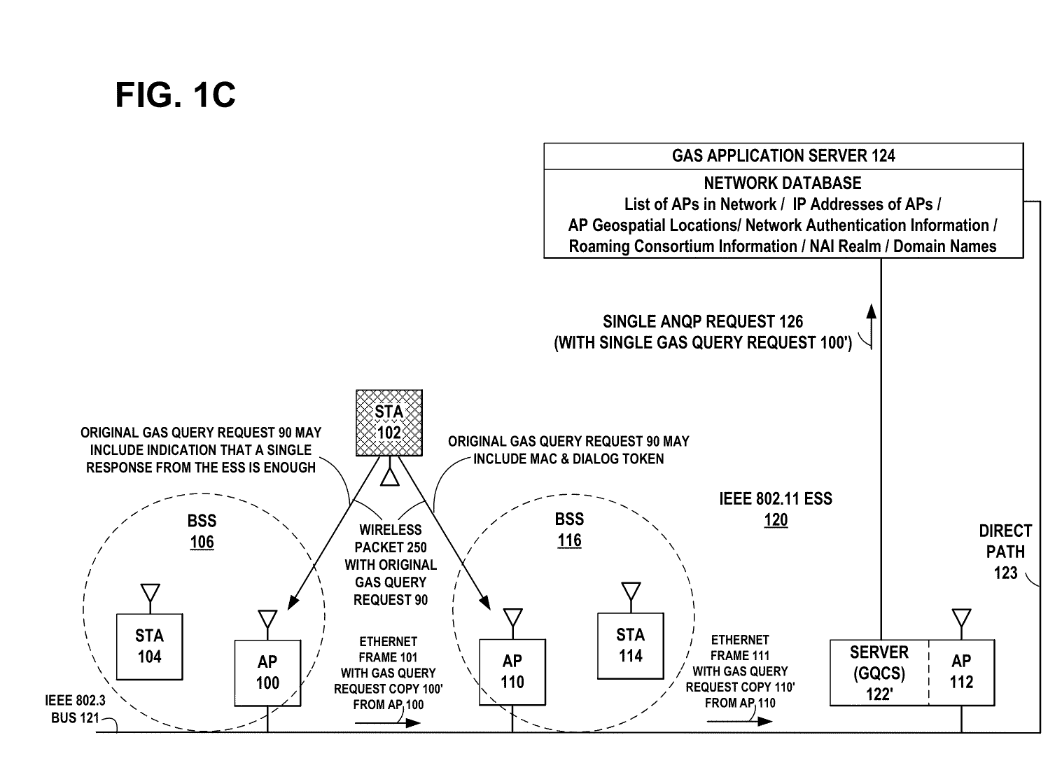

FIG. 1A illustrates an example network architecture comprising a mobile wireless device (STA) 102 broadcasting a generic advertising service (GAS) query request 90, an extended service set (ESS) 120 comprising two access point (AP) devices 100 and 110 in two respective infrastructure basic service set (BSS) networks 106 and 116, connected to a GAS query combination server (GQCS) 122. The GAS query request 90 may include an indication that a single response from the receiving access points in the ESS, is sufficient. The GAS query request 90 may also include a medium access control (MAC) address of the STA 102 and a Dialog Token assigned by the STA 102 to the GAS query response 90. The GAS query combination server (GQCS) 122 may be configured to determine the similarity of two copies 100′ and 110′ of the GAS query request 90 that are forwarded from the two respective access point devices 100 and 110. The determination by the GQCS may be based on the MAC address of the STA 102 and the Dialog Token in the received copies 100′ and 110′ of the GAS query request 90. The GAS query combination server (GQCS) may be further configured to transmit a single Access Network Query Protocol (ANQP) request corresponding to the two similar GAS Query requests 100′ and 110′, to a GAS application server 124, in accordance with an example embodiment of the invention.

The mobile wireless device (STA) 102 is shown broadcasting a generic advertising service (GAS) query request 90 in a wireless packet 250. The wireless generic advertisement service request packet 250 may be to a broadcast address. In an example embodiment of the invention, the generic advertising service (GAS) query request 90 may include an indication that a single response is sufficient. In another embodiment of the invention, the generic advertising service (GAS) query request 90 may not include a specific indicium that a single response is sufficient, but instead the indication that a single response is sufficient may be provided by a mandated requirement of a communications standard under which the STA 102 operates, that requires a single response to be sufficient.

In an example embodiment of the invention, the generic advertising service (GAS) query request 90 may be embedded in a wireless probe request or a separate wireless message.

In an example embodiment of the invention, the generic advertising service (GAS) query request 90 may include a medium access control address and a dialog token.

In an example embodiment of the invention, the access point 100 receiving the generic advertising service (GAS) query request 90 in the wireless packet 250, may transmit a copy 100′ of the generic advertisement service request 90 to the GAS query combination server (GQCS), if a single wireless generic advertisement service response is required. The access point 100 determines if a single wireless generic advertisement service response is required by the STA 102, by decoding the received generic advertising service (GAS) query request 90 and inspecting the field that indicates whether or not a single response is sufficient. If the generic advertising service (GAS) query request 90 indicates that a single response is sufficient, then the access point 100 transmits a copy 100′ of the generic advertisement service request 90 to the GAS query combination server (GQCS), the copy 100′ including the field that indicates a single response is sufficient. The access point 100 may embed the copy 100′ of the generic advertisement service request 90 in an IEEE 802.3 Ethernet frame 101 and transmit it over the Ethernet bus 121 to the GAS query combination server (GQCS).

In an example embodiment of the invention, if the generic advertising service (GAS) query request 90 does not indicate that a single response is sufficient, then the access point 100 may transmit a copy 100′ directly in an Access Network Query Protocol (ANQP) request, to the GAS application server 124, bypassing the GAS query combination server (GQCS). In an example embodiment of the invention, legacy access point devices may not recognize a field in the generic advertising service (GAS) query request 90 indicating that a single response is sufficient, and thus the legacy access point device may transmit a copy 100′ directly in an Access Network Query Protocol (ANQP) request, to the GAS application server 124, bypassing the GAS query combination server (GQCS).

Similarly, the access point 110 receiving the generic advertising service (GAS) query request 90 in the wireless packet 250, may transmit a copy 110′ of the generic advertisement service request 90 to the GAS query combination server (GQCS), if a single wireless generic advertisement service response is required. The access point 110 may embed the copy 110′ of the generic advertisement service request 90 in an Ethernet frame 111 and transmit it over the Ethernet bus 121 to the GAS query combination server (GQCS). In an example embodiment of the invention, if the generic advertising service (GAS) query request 90 does not indicate that a single response is sufficient, then the access point 110 may transmit a copy 110′ directly in an Access Network Query Protocol (ANQP) request, to the GAS application server 124, bypassing the GAS query combination server (GQCS).

The GAS query combination server (GQCS) 122 is shown receiving two copies of the generic advertising service (GAS) query request 90. The GQCS 122 receives the copy 100′ of the generic advertisement service request 90 in the Ethernet frame 101 and receives the second copy 110′ of the generic advertisement service request 90 in the Ethernet frame 111. In an example embodiment of the invention, the GAS query combination server (GQCS) 122 determines the similarity of the two copies of the generic advertising service (GAS) query request 90, based on their common medium access control (MAC) address of the STA 102 and the Dialog Token assigned by the STA 102 to the GAS query response 90. In accordance with an example embodiment of the invention, the GQCS 122 transmits a single Access Network Query Protocol (ANQP) request 126 with the copy of the GAS query request 100′, corresponding to the plurality of similar generic advertisement service requests it has received, sending it to the generic advertisement service application server 124. The GAS query combination server (GQCS) 122 may buffer the MAC address and the Dialog Token of the generic advertising service (GAS) query request copy 100′ or the copy 110′, so that it will recognize the ANQP response 127 from the GAS application server 124, and remember to append the instructions 129 to the GAS query response 125. The GAS query combination server (GQCS) 122 may also determine if a single wireless generic advertisement service response is required by the STA 102, by decoding the received generic advertising service (GAS) query request copy 100′ or the copy 110′ and inspecting the field that indicates whether or not a single response is sufficient.

The GAS application server 124 may return the GAS query response 125 in an ANQP response 127 to the sender of the ANQP request 126. If the GAS query combination server (GQCS) 122 sent the ANQP request 126, then the ANQP response 127 is returned to the GQCS 122. If the access point 100 sent the ANQP request 126 over the direct path 123, then the ANQP response 127 is returned to the access point 100 over the direct path 123. If the access point 110 sent the ANQP request 126 over the direct path 123, then the ANQP response 127 is returned to the access point 110 over the direct path 123.

FIG. 1B illustrates the example network architecture of FIG. 1A, wherein the GAS query combination server (GQCS) 122 is configured to receive an Access Network Query Protocol (ANQP) response 127 containing a GAS query response 125, responding to the ANQP request 126 from the GAS application server (GQCS) 122. In an example embodiment of the invention, the GAS query combination server (GQCS) 122 is further configured to transmit to each of the plurality of access points 100 and 110, instructions 129 to send at least one of: 1) a probe response with indication that a separate single GAS Query response is transmitted from single AP, 2) a combined probe response and GAS Query response with an indication that all GAS Query results from the extended service set (ESS) are duplicates, and/or 3) a probe response with indication of separate GAS Query response, and the separate GAS Query response with indication that also all other APs in the ESS have the same GAS Query response information, in accordance with an example embodiment of the invention.

In an example embodiment of the invention, the GAS query combination server (GQCS) 122 is shown transmitting to each of the plurality of access points 100 and 110, the Ethernet frame 128 containing the generic advertisement service response 125 and instructions 129 to the access points 100 and 110, to at least transmit to the mobile wireless device STA 102, the generic advertisement service response 125 with an indication to the STA 102 that all generic advertisement service responses that the STA 102 receives from access points in the ESS 120, are duplicates.

In an example embodiment of the invention, the instructions 129 to the access points 100 and 110 are to perform at least one of:
transmit a probe response to the STA 102 with an indication that a separate single wireless generic advertisement service response is transmitted from single access point device;
transmit a combined wireless probe response and the generic advertisement service response to the STA 102 with an indication that all generic advertisement service responses are duplicates; or
transmit a wireless probe response to the STA 102 with an indication of a separate generic advertisement service response, and transmit the separate generic advertisement service response to the STA 102 with an indication that all other responding access point devices have the same generic advertisement service response information.

In an example embodiment of the invention, the access points 100 and 110 are shown receiving the Ethernet frame 128 containing the generic advertisement service response 125 and instructions 129 to at least transmit the generic advertisement service response with an indication that all generic advertisement service responses are duplicates. The access points 100 and 110 are shown performing the instructions from the server, by transmitting a wireless packet 260 containing the GAS query response 125.

In an example embodiment of the invention, the access points 100 and 110 transmit wireless packet 260 to the STA 102, a probe response with an indication to the STA 102 that a separate single wireless generic advertisement service response is transmitted from single access point device.

In an example embodiment of the invention, the access points 100 and 110 transmit wireless packet 260 to the STA 102, a combined wireless probe response and the generic advertisement service response with an indication to the STA 102 that all generic advertisement service responses are duplicates.

In an example embodiment of the invention, the access points 100 and 110 transmit to the STA 102, a wireless probe response with an indication to the STA 102 of a separate generic advertisement service response, and transmit wireless packet 260, the separate generic advertisement service response with an indication to the STA 102 that all other responding access point devices have the same generic advertisement service response information.

In an example embodiment of the invention, the GAS Query Combination Server (GQCS) may add a notice that this is the only response, which it transmits to a single access point. To all other access points, the GAS Query Combination Server (GQCS) indicates that they will not get response to their GAS query request.

In an example embodiment of the invention, the access point 100 may indicate to the GQCS that it will transmit to the STA 102 a combined GAS and Probe response frame. The second GAS Query 110′ that was sent by the second access point 110, was not be forwarded by the GQCS to GAS Application Server and thus the GQCS indicates to the second access point 110 that access point 100 has already transmitted to the STA 102, the response its GAS query request.

FIG. 1C illustrates the example network architecture of FIG. 1A, wherein the functions of the GAS query combination server (GQCS) 122 are incorporated as GQCS functions 122′ as part of an access point device 112 in the same extended service set (ESS) 120 as the two access point devices 100 and 110 in the two respective infrastructure BSS networks 106 and 116. In an example embodiment of the invention, the GAS query combination server 122′ in the access point 112, is configured to determine the similarity of two GAS query requests 100′ and 110′ forwarded from the two respective access point devices 100 and 110, based on the MAC address and Dialog Token. The GAS query combination server 122′ in the access point 112, is further configured to transmit a single Access Network Query Protocol (ANQP) request 126 corresponding to the two similar GAS Query requests 100′ and 110′, to the GAS application server 124, in accordance with an example embodiment of the invention.

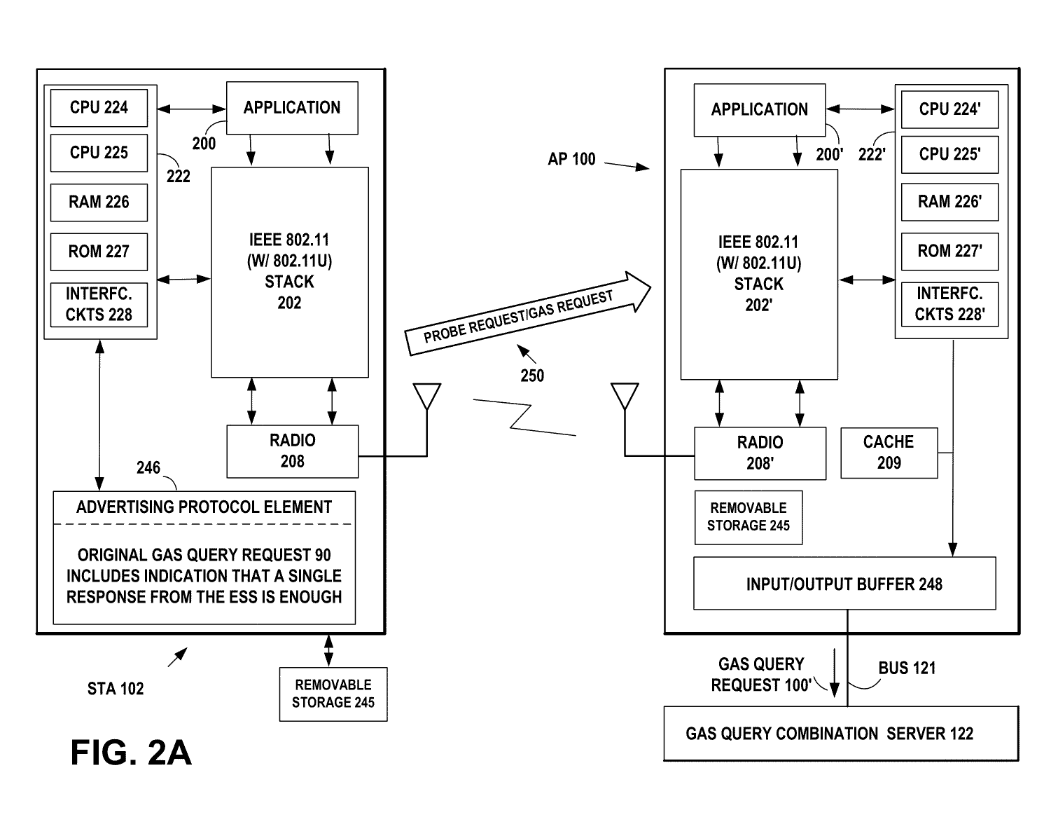

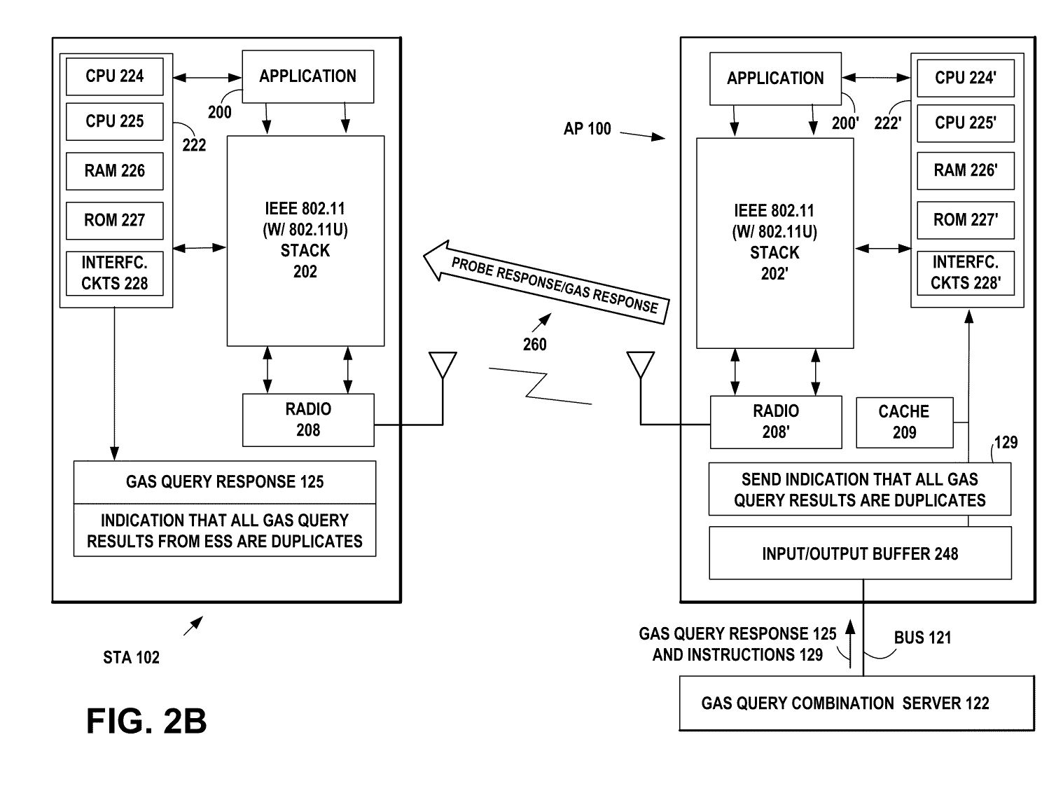

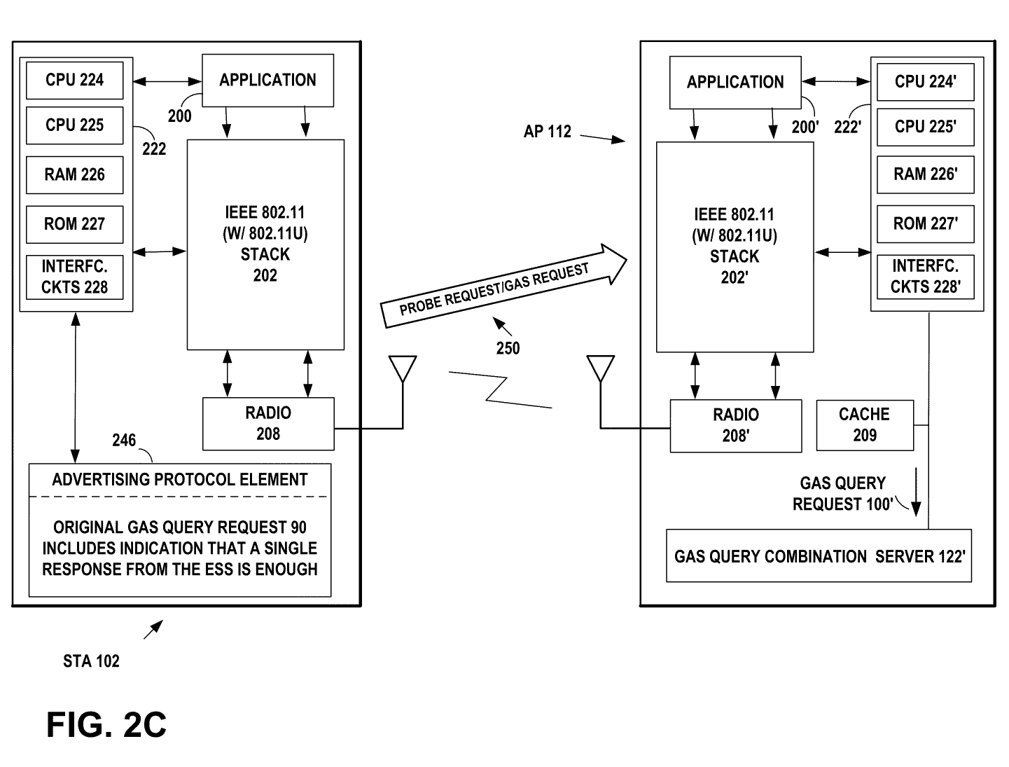

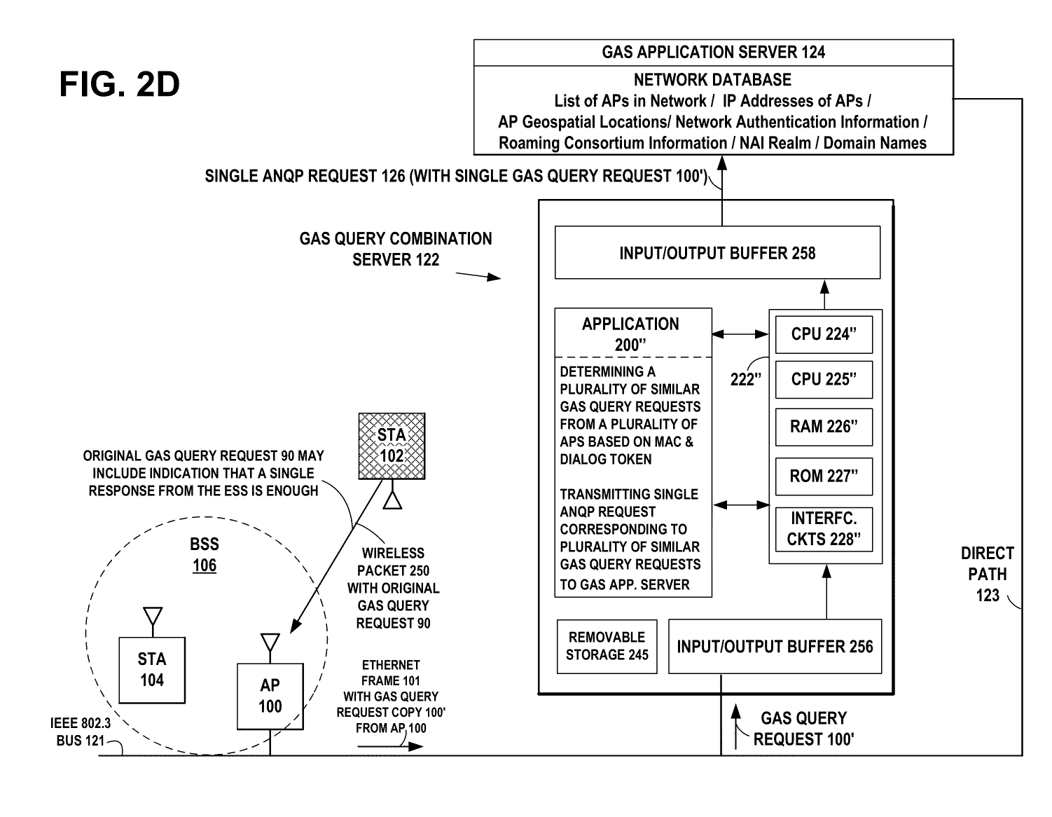

FIG. 2A illustrates an example wireless network and functional block diagram of the mobile wireless device 102 and the access point 100, with the mobile wireless device 102 groupcasting a combination probe request and generic advertisement service (GAS) request frame 250, including an indication that a single response from the extended service set (ESS) 120 is enough, in accordance with an example embodiment of the invention.

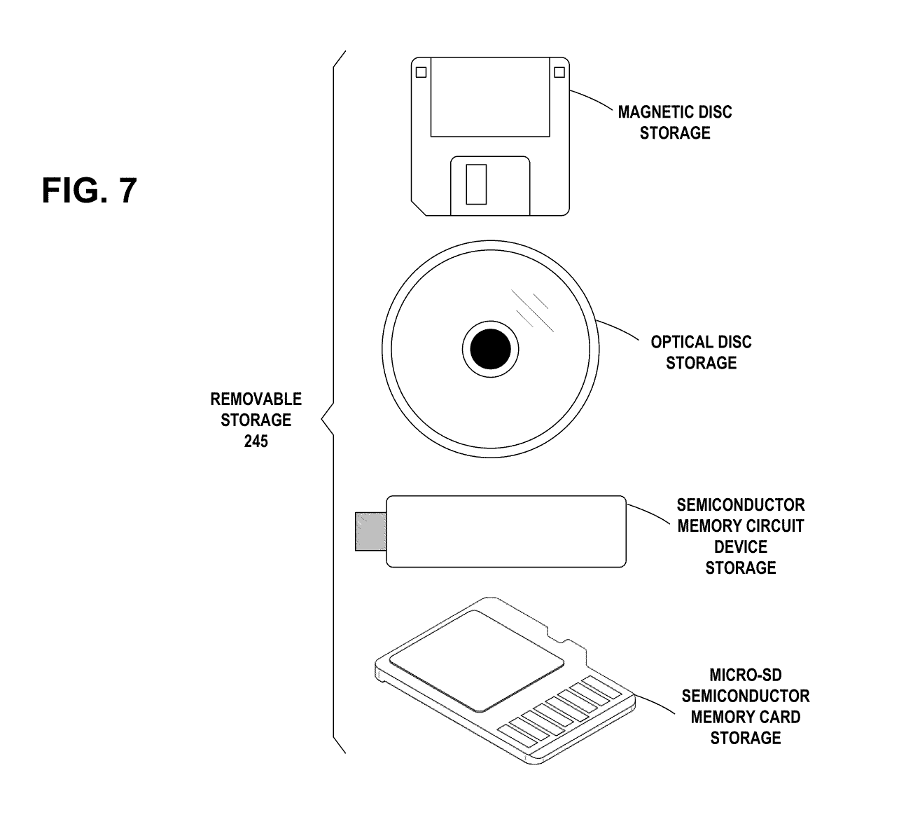

In accordance with example embodiments of the invention, the mobile wireless device STA 102 transmits the Generic Advertisement Service (GAS) request frame 250 as a groupcast, which may be either a broadcast or a multicast. The mobile wireless device STA 102 and the access point AP 100 are shown in FIGS. 2A and 2B in functional block diagram form to illustrate an example embodiment of their components. The wireless access point AP 100 includes a processor 222′, which includes a single core CPU or multiple core central processing unit (CPU) 224′ and 225′, a random access memory (RAM) 226′, a read only memory (ROM) 227′, and interface circuits 228′ to interface with one or more radio transceivers 208′, battery or house power sources, keyboard, display, etc. The RAM and ROM can be removable memory devices such as smart cards, SIMs, WIMs, semiconductor memories such as RAM, ROM, PROMS, flash memory devices, etc. FIG. 7 illustrates an example embodiment of the invention, wherein examples of removable storage media 245 are shown, that may be included in the mobile wireless device STA 102 and the access point AP 100.

The mobile wireless device STA 102 includes a processor 222, which includes a dual core central processing unit 224 and 225, a random access memory (RAM) 226, a read only memory (ROM) 227, and interface circuits 228 to interface with one or more radio transceivers 208, battery and other power sources, key pad, touch screen, display, microphone, speakers, ear pieces, camera or other imaging devices, etc. in the mobile wireless device STA 102. The RAM and ROM can be removable memory devices such as smart cards, SIMs, WIMs, semiconductor memories such as RAM, ROM, PROMS, flash memory devices, etc.

An example embodiment of the IEEE 802.11 protocol stack includes the IEEE 802.11u protocol 202 in the mobile wireless device STA 102. An example embodiment of the IEEE 802.11 protocol stack includes the IEEE 802.11u protocol 202′ in the access point device AP 100. The protocol stacks 202 and 202′ may be computer code instructions stored in the RAM and/or ROM memory of the respective processors 222 and 222′, which when executed by the central processing units (CPU), carry out the functions of the example embodiments of the invention.

The access point 100 includes an input/output buffer 248 that communicates over the Ethernet bus 121 with the GAS query combination server 122.

The access point 100 includes a cache 209 to buffer the generic advertisement service responses 125 and instructions 129 from the GAS query combination server 122. In accordance with an example embodiment of the invention, the access point 100 may access the cache memory 209 and transmit the buffered generic advertisement service responses to at least one access point 100 or 110, without transmitting a query to the GAS application server 124, if there is a delay in receiving a response from the GAS application server 124 for the generic advertisement service request 100′.

FIG. 2B illustrates the example wireless network and functional block diagram of FIG. 2A, of the mobile wireless device 102 and the access point 100, with the access point 100 transmitting a combination probe response and generic advertisement service (GAS) response frame 260, with an indication that all GAS Query results from the extended service set (ESS) 120 are duplicates, in accordance with an example embodiment of the invention.

FIG. 2C illustrates the example wireless network and functional block diagram of FIG. 2A, wherein the functions of the GAS query combination server (GQCS) 122 are incorporated as part of an access point device 112, in accordance with an example embodiment of the invention.

FIG. 2D illustrates the example wireless network and functional block diagram of the GAS query combination server (GQCS) 122, in accordance with an example embodiment of the invention. The GAS query combination server (GQCS) 122 shown in FIG. 2D in functional block diagram form, illustrates an example embodiment of its components. The GAS query combination server (GQCS) 122 includes a processor 222″, which includes a single core CPU or multiple core central processing unit (CPU) 224″ and 225″, a random access memory (RAM) 226″, a read only memory (ROM) 227″, and interface circuits 228″ to interface with battery or house power sources, keyboard, display, etc. The RAM and ROM can be removable memory devices such as smart cards, SIMs, WIMs, semiconductor memories such as RAM, ROM, PROMS, flash memory devices, etc. FIG. 7 illustrates an example embodiment of the invention, wherein examples of removable storage media 245 are shown, that may be included in the GAS query combination server (GQCS) 122. The GAS query combination server (GQCS) 122 includes an input/output buffer 256 that communicates over the Ethernet bus 121 with the access points 100 and 110. The GAS query combination server (GQCS) 122 includes an input/output buffer 258 that communicates with the GAS application server 124.

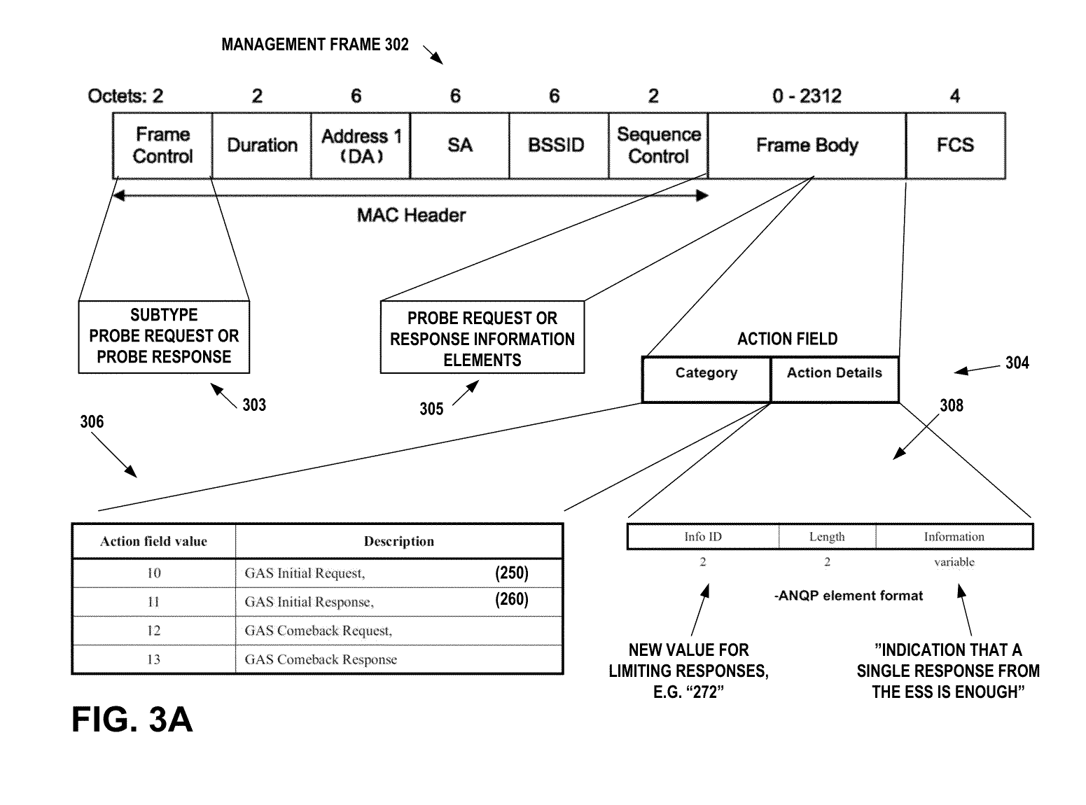

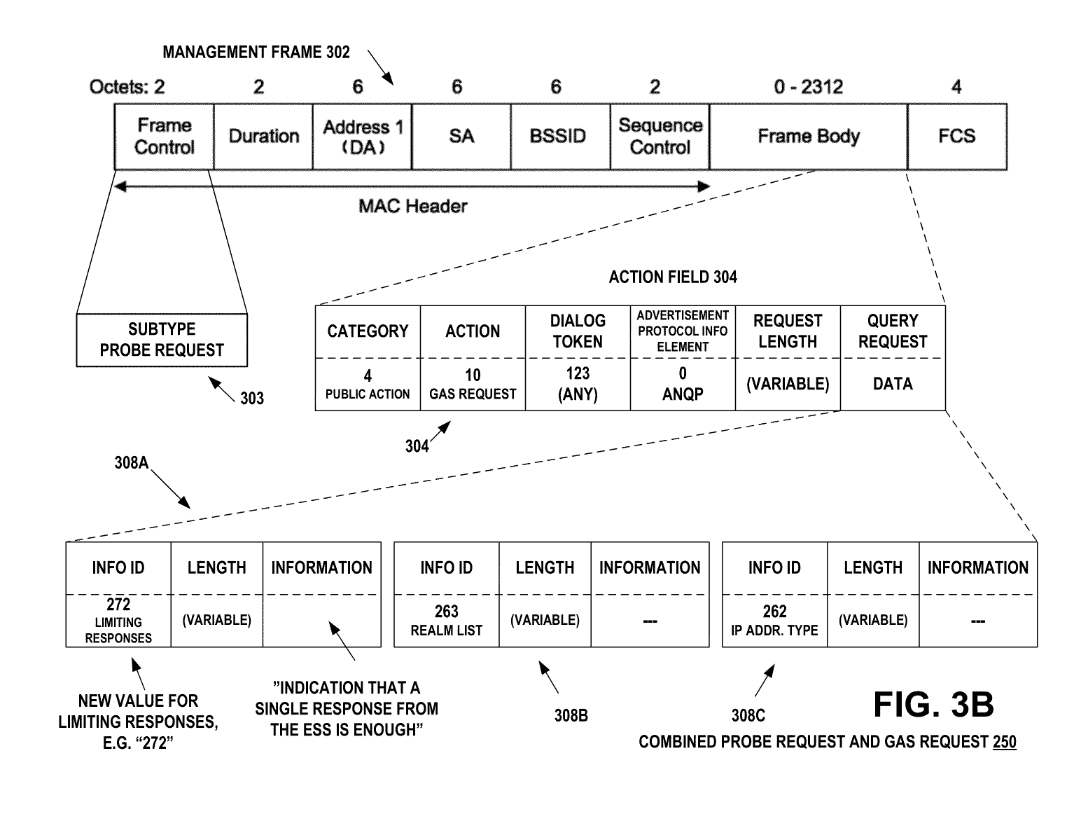

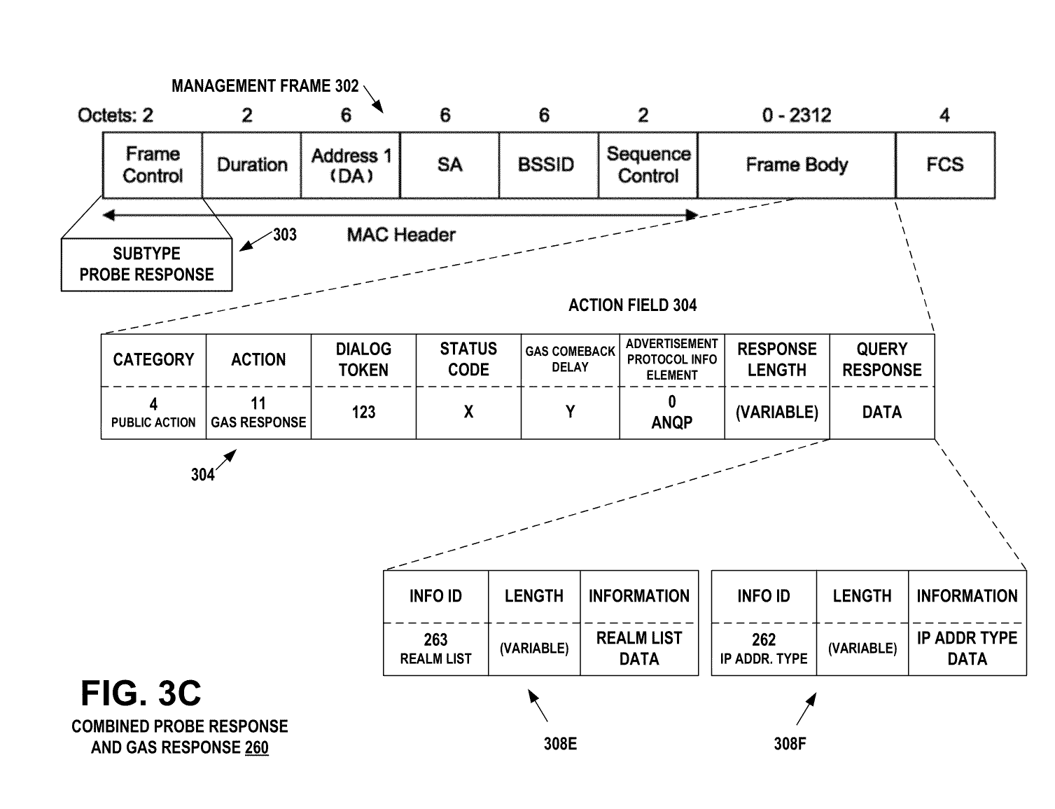

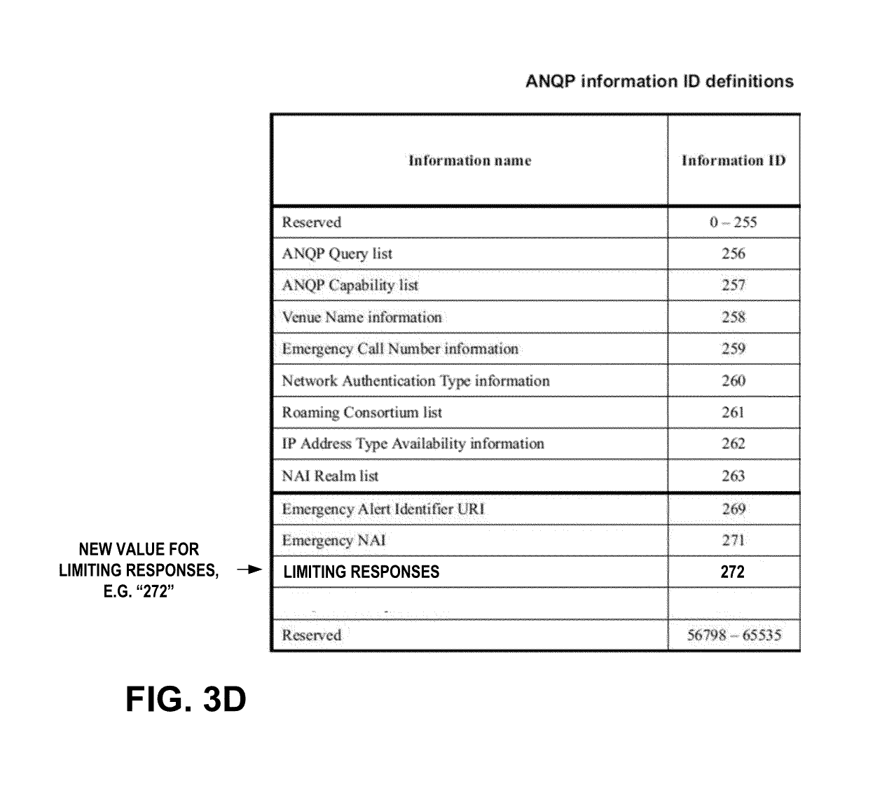

FIG. 3A illustrates an example combination probe request and Generic Advertisement Service (GAS) request frame of an IEEE 802.11 MAC management frame, in accordance with an example embodiment of the invention. The IEEE 802.11 MAC management frame 302 shown in FIG. 3A has the frame control field indicate that this is a management frame, the frame subtype field 303 is set to indicate either a probe request or a probe response. The MAC address of the mobile wireless device STA 102 is in the source field SA. The frame body includes information elements 305 for the probe request or probe response and the frame body also includes an action field 304 that indicates that a GAS query request is also embedded in the frame body. The action field 304 includes a category field that indicates a public action frame to allow communications between an access point and an unassociated STA. The action field 304 may be set to one of several values indicated in the table 306. An action field value of 10 indicates a GAS Initial Request, transmitted by a requesting STA to request information from another STA. An action field value of 11 indicates a GAS Initial Response, transmitted by a STA responding to a GAS Initial Request frame. An action field value of 12 indicates a GAS Comeback Request, transmitted by a requesting STA to a responding STA. An action field value of 13 indicates a GAS Comeback Response, transmitted by a responding STA to a requesting STA.

FIG. 3B illustrates an example frame body format of the combination probe request and Generic Advertisement Service (GAS) Request Frame 250, in accordance with an example embodiment of the invention. The frame subtype field 303 is set to indicate a probe request and the frame body includes information elements 305 for the probe request. The MAC address of the mobile wireless device STA 102 is in the source field SA. The action field 304 of the frame body format of the GAS initial request frame 250 shown in FIG. 3B, includes the category field that indicates a public action frame with Category field value 4, to allow communications between an access point and an unassociated STA. The public action field value 304 is set to value of 10 or 11 to indicate GAS initial request or GAS initial response, respectively. The advertisement information protocol element field specifies an advertisement protocol ID of “0”, which is the access network query protocol (ANQP) format for the ANQP element 308.

ANQP elements 308 are defined to have a common format consisting of a 2-octet Info ID field, a 2-octet length field, and a variable-length element-specific information field. Each element is assigned a unique Info ID as shown in the ANQP Information ID definitions of FIG. 3D.

As shown in FIG. 3B, when the public action field 304 is set to value of 10 to indicate GAS initial request 250, several ANQP information elements 308 may be sent in the query request field. In an example embodiment of the invention, the ANQP element 308A has a new INFO ID of “272” for “Limiting Responses”. The information field of the ANQP element 308A contains the “indication that a single response from the ESS is enough”. The ANQP elements 308B and 308C respectively contain the query request “263”=“realm list” and “262”=“IP address type” sent from the mobile wireless device STA 102 to the access point AP 100. The dialog token field is set by the requesting station STA 102 with any value, such as “123”, to identify the GAS initial request frame. The GAS initial request frame 250 includes a length value for the length of the following query request field. The Generic Advertisement Service (GAS) initial request frame 250 may be used for interworking between wireless networks in different realms.

FIG. 3C illustrates an example frame body format of the combination probe response and Generic Advertisement Service (GAS) Response Frame 260, in accordance with an example embodiment of the invention. The frame subtype field 303 is set to indicate a probe response and the frame body includes information elements 305 for the probe response. The MAC address of the mobile wireless device STA 102 is in the destination field DA. The action field 304 in the frame body has a value set to value of 11 to indicate a GAS initial response 260. As shown in FIG. 3C, when the action field 304 is set to value of 11 to indicate GAS initial response 260, several ANQP information elements 308 may be sent in the query response field. The ANQP elements 308E and 308F respectively contain the query response data “263” for the realm list data and “262” for the IP address type data, that is sent from the access point AP 100 to the mobile wireless device STA 102. The information field of the ANQP elements 308E and 308F contain the requested data sent from the access point AP 100, which may be in one or multiple ANQP info elements 308. The dialog token field has the same value, such as “123”, as in the GAS initial request frame.

FIG. 3D illustrates an example of ANQP Information ID Definitions for the ANQP info elements 308. In accordance with an embodiment of the invention, a new ANQP information ID definition is provided to define the response condition of the GAS initial request 250 sent from the mobile wireless device STA 102, and it is indicated by a new information ID number, for example “272”. An example ANQP element 308A having an Info ID=272 indicating that it defines “limiting responses”, is shown in FIG. 3B for the GAS initial request frame 250. The example ANQP element 308A may, itself, contain additional information listing the specified characteristics that are required, or alternately it may be accompanied by other ANQP elements 308B and 308C, for example, that list the specified characteristics that are required.

For example, the information field of the ANQP element 308A in FIG. 3B, is an “indication that a single response from the ESS is enough”. The accompanying ANQP elements 308B and 308C respectively contain the query request “263”=“realm list” and “262”=“IP address type” as the specified characteristics that are required from the access point AP 100.

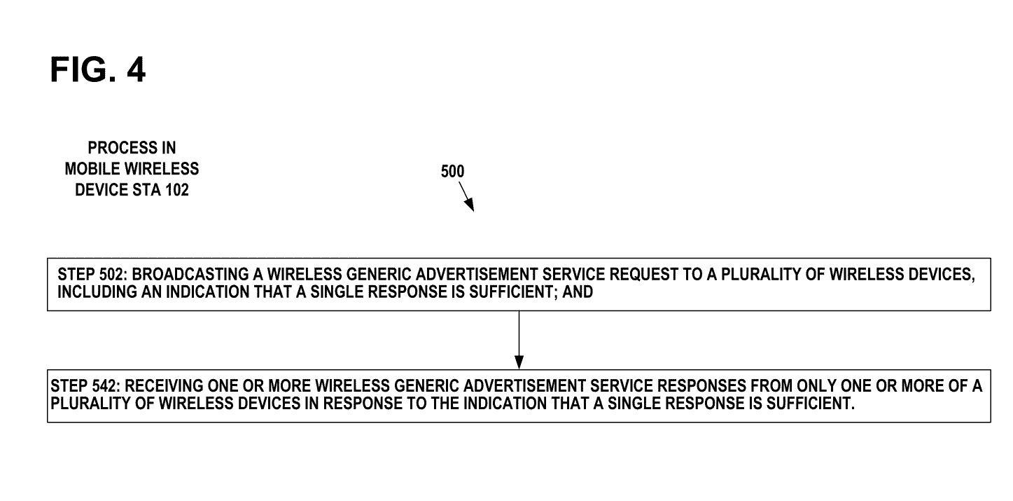

FIG. 4 illustrates an example embodiment of a flow diagram 500 for the process in the mobile wireless device STA 102. FIG. 4 is an example of steps in the procedure carried out by the device in executing-in-place program code stored in the memory of the device. The steps in the procedure of the flow diagram may be embodied as program logic stored in the memory of the wireless device in the form of sequences of programmed instructions which, when executed in the microprocessor control logic of the device, carry out the functions of an exemplary disclosed embodiment. The steps may be carried out in another order than shown and individual steps may be combined or separated into component steps. Additional steps may be inserted into this sequence. The steps in the procedure are as follows:

Step 502: broadcasting a wireless generic advertisement service request to a plurality of wireless devices, including an indication that a single response is sufficient; and

Step 542: receiving one or more wireless generic advertisement service responses from only one or more of a plurality of wireless devices in response to the indication that a single response is sufficient.

In an example embodiment of the invention, the indication that a single response is sufficient may be provided by a mandated requirement of a communications standard under which the wireless generic advertisement service request is broadcast, the communications standard requiring a single response to be sufficient.

In an example embodiment of the invention, the wireless generic advertisement service request broadcast by the STA 102, may include response criteria parameters to control devices that respond to the request. The wireless generic advertisement service request may be limited by parameters, such as signal quality, QoS performance, inclusion list of addresses or exclusion list of addresses, and the like.

In an example embodiment of the invention, the STA 102 may receive multiple wireless generic advertisement service responses that indicate a subset of GAS parameters that are needed for link setup that are the same for a plurality of access points. For instance network realms may be the same for all access points.

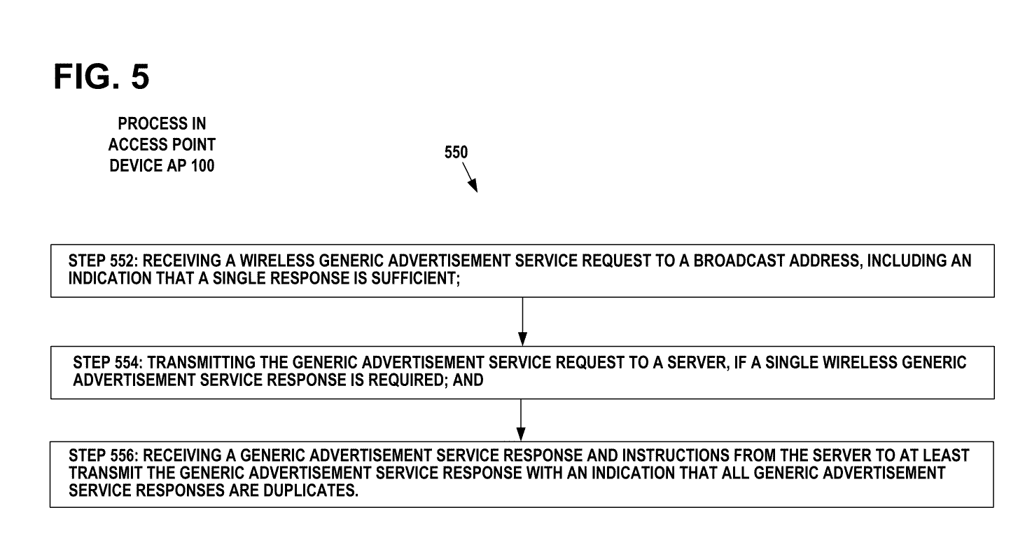

FIG. 5 illustrates an example embodiment of a flow diagram 550 for the process in the access point device AP 100. FIG. 5 is an example of steps in the procedure carried out by the device in executing-in-place program code stored in the memory of the device. The steps in the procedure of the flow diagram may be embodied as program logic stored in the memory of the wireless device in the form of sequences of programmed instructions which, when executed in the microprocessor control logic of the device, carry out the functions of an exemplary disclosed embodiment. The steps may be carried out in another order than shown and individual steps may be combined or separated into component steps. Additional steps may be inserted into this sequence. The steps in the procedure are as follows:

Step 552: receiving a wireless generic advertisement service request to a broadcast address, including an indication that a single response is sufficient;

Step 554: transmitting the generic advertisement service request to a server, if a single wireless generic advertisement service response is required; and

Step 556: receiving a generic advertisement service response and instructions from the server to at least transmit the generic advertisement service response with an indication that all generic advertisement service responses are duplicates.

In an example embodiment of the invention, the wireless generic advertisement service request may be a combined Probe Request and GAS Query initiation request. The access point 100 may transmit to the STA 102, a Probe Response in response to the Probe Request. The access point 100 may transmit the GAS Query initiation request to the GQCS server 122. The access point 100 may receive a GAS Query response and instructions from the server 122 indicating that the transmitted Probe Response was a first occurring transmission of a Probe Response to the STA 102. The access point 100 may transmit the GAS Query response to the STA 102 in response to the instructions indicating that the transmitted Probe Response was a first occurring transmission of a Probe Response.

In an example embodiment of the invention, the Probe Response may include an indication that a GAS Response will follow.

In an example embodiment of the invention, the wireless generic advertisement service request may be a combined Probe Request and GAS Query initiation request. The access point 100 may transmit to the STA 102, a Probe Response in response to the Probe Request. The access point 100 will know if it is the first to transmit a probe response, since it will receive any other probe responses by other access points within range. If the access point has not received any Probe Response frame that is transmitted as a response to the Probe Request, the access point considers itself to be the first responder. The access point 100 that is the first responder may transmit the GAS Query initiation request to the GQCS server 122. Thus only a single request is initiated to the GAS application server. Also the STA 102 detects which AP was the first responding AP and it knows to expect response from the AP and the transmitted Probe Response frames cancel the GAS queries.

In an example embodiment of the invention, the wireless generic advertisement service request may be a combined Probe Request and GAS Query initiation request. The access point 100 may transmit to the STA 102, a Probe Response in response to the Probe Request. The access point 100 may receive a GAS Query response and instructions from the server 122 indicating that the transmitted Probe Response was a first occurring transmission of a Probe Response to the STA 102. The access point 100 may delete the GAS Query response from its I/O buffer in response to the instructions indicating that the transmitted Probe Response was not a first occurring transmission of a Probe Response.

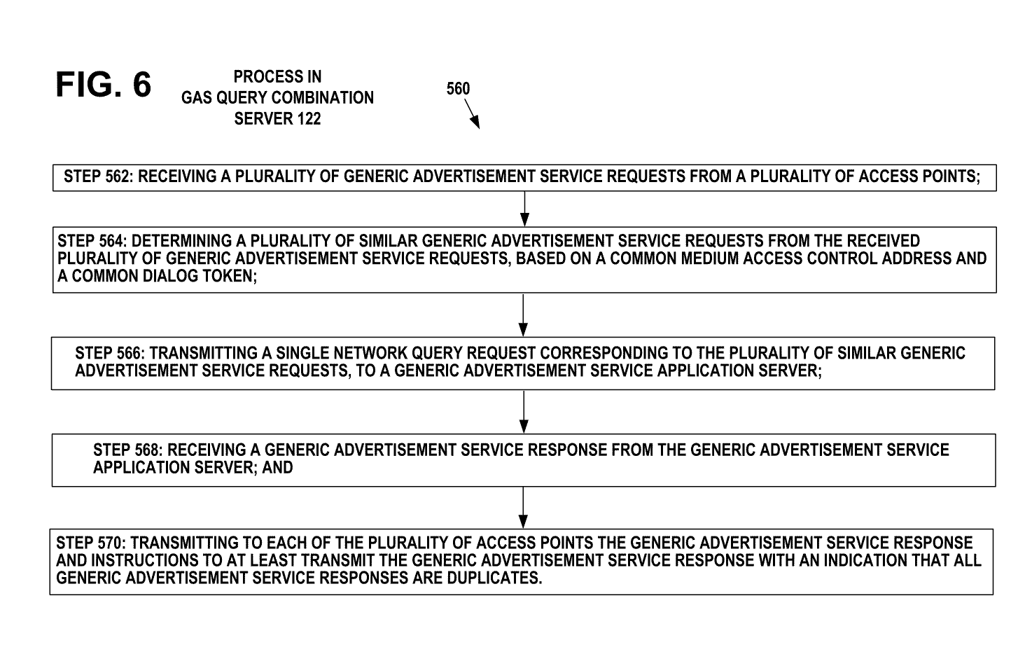

FIG. 6 illustrates an example embodiment of a flow diagram 560 for the process in the GAS query combination server 122. FIG. 6 is an example of steps in the procedure carried out by the device in executing-in-place program code stored in the memory of the device. The steps in the procedure of the flow diagram may be embodied as program logic stored in the memory of the wireless device in the form of sequences of programmed instructions which, when executed in the microprocessor control logic of the device, carry out the functions of an exemplary disclosed embodiment. The steps may be carried out in another order than shown and individual steps may be combined or separated into component steps. Additional steps may be inserted into this sequence. The steps in the procedure are as follows:

Step 562: receiving a plurality of generic advertisement service requests from a plurality of access points;

Step 564: determining a plurality of similar generic advertisement service requests from the received plurality of generic advertisement service requests, based on a common medium access control address and a common dialog token;

Step 566: transmitting a single network query request corresponding to the plurality of similar generic advertisement service requests, to a generic advertisement service application server;

Step 568: receiving a generic advertisement service response from the generic advertisement service application server; and

Step 570: transmitting to each of the plurality of access points the generic advertisement service response and instructions to at least transmit the generic advertisement service response with an indication that all generic advertisement service responses are duplicates.

In an example embodiment of the invention, wherein the instructions transmitted by the GQCS server 122 are to transmit a separate single wireless generic advertisement service response by a single access point device that is specified by the mobile wireless device in the wireless generic advertisement service request.

In an example embodiment of the invention, wherein the single network query request transmitted by the GQCS server 122 to the generic advertisement service application server, includes information for instructing an access point to set information fields in a generic advertisement service response.

FIG. 7 illustrates an example embodiment of the invention, wherein examples of removable storage media 245 are shown, based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

In an example embodiment of the invention, the GAS query combination server (GQCS) architecture enables coordination of the number of the GAS queries sent to the GAS application server.

In an example embodiment of the invention, signaling reduces overhead and increases reliability of the over-the-air signaling of the GAS query responses, by specifying how the GAS Query Responses are transmitted. The signaling may specify delayed GAS Query Response transmission and also enable the result of the GAS Query to be transmitted as separate frame, such as a Probe Response. The GAS Query Response may indicate if it is transmitted as response to multiple GAS Query requests. The GAS Query Response may indicate if an ESS or Roaming Consortium will transmit only a single response, or if duplicated GAS Query Response frames will be transmitted.

In an example embodiment of the invention, GAS requests that are combined with a Probe Request and transmitted to a broadcast address, may contain the MAC address of the requesting STA and the Dialog Token of the request. The MAC address of the requesting STA is a unique address that specifies the requesting STA. The Dialog Token is a number that specifies the Probe Request is a sequence, which is being transmitted. Together these fields uniquely specify the Probe Request that is transmitted. These fields may be used to filter the amount of GAS Queries that are performed.

In an example embodiment of the invention, the GAS queries are filtered to avoid multiple copies of the same query operation being sent to the same GAS application server. The access points typically know the GAS application server that serves it and is the same server being used by other access points in the ESS or Roaming consortium. For example, the access points that belong to the same ESS may perform only a single query to the GAS application server. The access points that belong to the same roaming consortium specific server may perform a single query to the GAS application server.

In an example embodiment of the invention, the GAS query combination server (GQCS) provides an architecture and operation model to reduce the number of queries to the GAS application server. In an example embodiment of the invention, an enhancement to the GAS application server adds a cache memory that enables the GAS application server to cache the responses. The GAS application server may then then detect new queries and it may respond with existing cached information. In an example embodiment of the invention, the access points may jointly communicate in the local area network and coordinate which access point will transmit the GAS Query request to the GAS application Server.

In an example embodiment of the invention, when the Probe Request that includes a GAS Query, is transmitted to broadcast address, it may have multiple responding STAs. Each AP that received the GAS Query initiation request may perform the GAS query. When the AP receives a GAS query initiation frame, the AP forwards the GAS query initiation frame to the GAS Query Combination server (GQCS). The GQCS controls the amount of GAS queries that will be sent to the GAS application server.

In an example embodiment of the invention, the GQCS may receive the content of the GAS query, with the whole payload of the MPDU packet, including the MAC addresses of the source and the receiver STA.

In an example embodiment of the invention, in a distributed approach, the APs that receive the GAS Request may coordinate over the distribution service (DS), wired backbone or over the Wireless Distribution Service (WDS), air interface, to negotiate which AP will perform the query to the GAS application server.

In an example embodiment of the invention, in a Server based implementation, the GAS application server may typically be located close to the APs and the GAS application server itself receives many requests. The GAS application server may be capable of detecting the duplicate requests and it may indicate in its responses that it has already provided a response to the query, or avoid duplicating the response to the query and filter the duplicate queries.

In an example embodiment of the invention, in a default implementation, the GQCS server may be located close to the APs, so that messages are delivered fast from the APs to the GQCS. The GQCS receives the GAS Query requests from the APs. The GQCS creates the Access Network Query Protocol (ANQP) specific Queries and coordinates the amount of queries sent to the GAS application servers. The default and distributed implementation approaches may need no changes to the GAS application server.

In an example embodiment of the invention, the GAS query response may be added to probe response, or it may be transmitted as a separate frame. If the GAS query response is transmitted as separate frame, the Probe Response may indicate that GAS Query response will be transmitted as separate frame. A single GAS Query Response frame may be transmitted. Other responding APs transmit a Probe Response frame. The Probe Response frames have a bit set that indicates that a separate GAS Query Response frame will be transmitted. If the GAS Query response is delayed, the time for Query Response transmission is indicated. This operation is similar to the delayed GAS Query Response, but the Probe Response replaces the GAS Query Comeback Query Response frame.

In an example embodiment of the invention, a GAS query response may be transmitted in the Probe Response frame. When multiple STAs respond to the GAS Query: (merging multiple queries), duplicate GAS Query results may be transmitted in multiple responses. The combined Probe Response and GAS Query Response frame have a bit that indicates that all GAS query results from the ESS or Roaming Consortium are duplicates. A Single GAS Query result may be transmitted in a single Probe Response frame. Other Probe Responses may indicate that a single frame contains the GAS Query response.

In an example embodiment of the invention, legacy devices may not understand the new appended information elements and they will respond only to the probe request frame. The scanning STA may detect responses from legacy devices and do GAS query separately for these STAs.

In an example embodiment of the invention, the reduction of the GAS queries reduces the amount of traffic in the backbone and makes the message exchange faster. The reduction of the queries reduces the amount of traffic in the GAS server and lowers the efficiency requirements of the server. The reduction of the number of GAS queries reduces especially the peak resource consumption and makes the server operation more reliable.

In an example embodiment of the invention, the information of the GAS query response transmissions helps the requesting STA to know the number of GAS Query responses it should expect from the BSS. This enables the STA to make decisions when it may start fast initial link setup. The reduced amount of GAS query responses lowers the overhead of the discovery. The information that the same response will be repeated in several GAS Query Response makes the delivery of the frame more reliable.

The example principles of operation of an embodiment the invention described herein may be employed in networks other than Wireless LAN networks and may be any of a variety of wireless personal area, wireless local area, or wireless wide area radio networks, such as Land Mobile Radio, Professional Mobile Radio, DECT (Digital Enhanced Cordless Telecommunications), 1G, 2G, 3G, 4G Cellular systems, IrDA, RFID (Radio Frequency Identification), Wireless USB, DSRC (Dedicated Short Range Communications), Near Field Communication, wireless sensor networks, ZigBee, EnOcean; Bluetooth, TransferJet, Ultra-wideband (UWB from WiMedia Alliance), WLAN, IEEE 802.11, WiFi, HiperLAN, Wireless Metropolitan Area Networks (WMAN) and Broadband Fixed Access (BWA) (LMDS, WiMAX, AIDAAS and HiperMAN), or the like.

In an example embodiment of the invention, an apparatus comprises:
means for broadcasting a wireless generic advertisement service request to a plurality of wireless devices, including an indication that a single response is sufficient; and
means for receiving one or more wireless generic advertisement service responses from only one or more of a plurality of wireless devices in response to the indication that a single response is sufficient.

In an example embodiment of the invention, an apparatus comprises:
means for receiving a wireless generic advertisement service request to a broadcast address, including an indication that a single response is sufficient;
means for transmitting the generic advertisement service request to a server, if a single wireless generic advertisement service response is required; and
means for receiving a generic advertisement service response and instructions from the server to at least transmit the generic advertisement service response with an indication that all generic advertisement service responses are duplicates.

In an example embodiment of the invention, an apparatus comprises:
means for receiving a plurality of generic advertisement service requests from a plurality of access points;
means for determining a plurality of similar generic advertisement service requests from the received plurality of generic advertisement service requests, based on a common medium access control address and a common dialog token;
means for transmitting a single network query request corresponding to the plurality of similar generic advertisement service requests, to a generic advertisement service application server;
means for receiving a generic advertisement service response from the generic advertisement service application server; and
means for transmitting to each of the plurality of access points the generic advertisement service response and instructions to at least transmit the generic advertisement service response with an indication that all generic advertisement service responses are duplicates.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable, non-transitory medium.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments have been disclosed, a person skilled in the art will understand that changes can be made to the specific example embodiments without departing from the spirit and scope of the invention. For instance, the features described herein may be employed in networks other than Wireless LAN networks.

What is claimed is:

1. A method, comprising:
broadcasting a wireless generic advertisement service request to a plurality of wireless devices, including an indication that a single response is sufficient; and
receiving one or more wireless generic advertisement service responses from only one or more of the plurality of wireless devices in response to the indication that a single response is sufficient.

2. The method of claim 1, wherein the generic advertisement service request is one of embedded in a wireless probe request or a separate wireless message.

3. The method of claim 1, wherein the generic advertisement service request includes a medium access control address and a dialog token.

4. The method of claim 1, wherein the generic advertisement service response is one of embedded in a wireless probe response or a separate wireless message.

5. The method of claim 1, further comprising:
receiving a wireless probe response that includes an indication that a separate single wireless generic advertisement service response is transmitted from only one of the plurality of wireless devices in response to the indication that a single response is sufficient.

6. The method of claim 1, further comprising:
receiving a wireless probe response that includes an indication of an estimated time for receipt of a delayed wireless generic advertisement service response.

7. The method of claim 1, further comprising:
receiving multiple wireless generic advertisement service responses that indicate all of the received wireless generic advertisement service responses are duplicates.

8. The method of claim 1, further comprising:
receiving multiple wireless generic advertisement service responses embedded in a wireless probe response that indicates all of the received wireless generic advertisement service responses are duplicates.

9. A method, comprising:
receiving a wireless generic advertisement service request to a broadcast address, including an indication that a single response is sufficient;
transmitting the generic advertisement service request to a server, if a single wireless generic advertisement service response is required; and
receiving a generic advertisement service response and instructions from the server to at least transmit the generic advertisement service response with an indication that all generic advertisement service responses are duplicates.

10. The method of claim 9, wherein the instructions from the server are to perform at least one of:
transmit a probe response with an indication that a separate single wireless generic advertisement service response is transmitted from single access point device;
transmit a combined wireless probe response and the generic advertisement service response with an indication that all generic advertisement service responses are duplicates; or
transmit a wireless probe response with an indication of a separate generic advertisement service response, and transmit the separate generic advertisement service response with an indication that all other responding access point devices have the same generic advertisement service response information.

11. A method, comprising:
receiving a plurality of generic advertisement service requests from a plurality of access points;
determining a plurality of similar generic advertisement service requests from the received plurality of generic advertisement service requests, based on a common medium access control address and a common dialog token;
transmitting a single network query request corresponding to the plurality of similar generic advertisement service requests, to a generic advertisement service application server;
receiving a generic advertisement service response from the generic advertisement service application server; and
transmitting to at least one of the plurality of access points the generic advertisement service response and instructions to at least transmit the generic advertisement service response with an indication that all generic advertisement service responses are duplicates.

12. The method of claim 11, wherein the instructions are to perform at least one of:
transmit a probe response with an indication that a separate single wireless generic advertisement service response is transmitted from single access point device;
transmit a combined wireless probe response and the generic advertisement service response with an indication that all generic advertisement service responses are duplicates; or
transmit a wireless probe response with an indication of a separate generic advertisement service response, and transmit the separate generic advertisement service response with an indication that all other responding access point devices have the same generic advertisement service response information.

13. An apparatus, comprising:
at least one processor;
at least one memory including computer program code;
the at least one memory and the computer program code configured to, with the at least one processor, cause the device at least to:
broadcast a wireless generic advertisement service request to a plurality of wireless devices, including an indication that a single response is sufficient; and
receive one or more wireless generic advertisement service responses from only one or more of the plurality of wireless devices in response to the indication that a single response is sufficient.

14. The apparatus of claim 13, wherein the generic advertisement service request is one of embedded in a wireless probe request or a separate wireless message.

15. The apparatus of claim 13, wherein the generic advertisement service request includes a medium access control address and a dialog token.

16. The apparatus of claim 13, wherein the generic advertisement service response is one of embedded in a wireless probe response or a separate wireless message.

17. The apparatus of claim 13, further comprising:
the at least one memory and the computer program code configured to, with the at least one processor, cause the device at least to:
receive a wireless probe response that includes an indication that a separate single wireless generic advertisement service response is transmitted from only one of the plurality of wireless devices in response to the indication that a single response is sufficient.

18. The apparatus of claim 13, further comprising:
the at least one memory and the computer program code configured to, with the at least one processor, cause the device at least to:
receive a wireless probe response that includes an indication of an estimated time for receipt of a delayed wireless generic advertisement service response.

19. The apparatus of claim 13, further comprising:
the at least one memory and the computer program code configured to, with the at least one processor, cause the device at least to:
receive multiple wireless generic advertisement service responses that indicate all of the received wireless generic advertisement service responses are duplicates.

20. The apparatus of claim 13, further comprising:
the at least one memory and the computer program code configured to, with the at least one processor, cause the device at least to:
receive multiple wireless generic advertisement service responses embedded in a wireless probe response that indicates all of the received wireless generic advertisement service responses are duplicates.

21. A apparatus, comprising:
at least one processor;
at least one memory including computer program code;
the at least one memory and the computer program code configured to, with the at least one processor, cause the device at least to:
receive a wireless generic advertisement service request to a broadcast address, including an indication that a single response is sufficient;
transmit the generic advertisement service request to a server, if a single wireless generic advertisement service response is required; and
receive a generic advertisement service response and instructions from the server to at least transmit the generic advertisement service response with an indication that all generic advertisement service responses are duplicates.

22. The apparatus of claim 21, wherein the instructions from the server are to perform at least one of:
transmit a probe response with an indication that a separate single wireless generic advertisement service response is transmitted from single access point device;
transmit a combined wireless probe response and the generic advertisement service response with an indication that all generic advertisement service responses are duplicates; or
transmit a wireless probe response with an indication of a separate generic advertisement service response, and transmit the separate generic advertisement service response with an indication that all other responding access point devices have the same generic advertisement service response information.

23. The apparatus of claim 21, further comprising:
the at least one memory and the computer program code configured to, with the at least one processor, cause the device at least to:
buffer the generic advertisement service responses and instructions from the server, in a cache memory of the apparatus; and
access the cache memory and transmit the buffered generic advertisement service responses to at least one access point, without transmitting a query to the server, if there is a delay in receiving a response from the server for the generic advertisement service request.

24. A apparatus, comprising:
at least one processor;
at least one memory including computer program code;
the at least one memory and the computer program code configured to, with the at least one processor, cause the device at least to:
receive a plurality of generic advertisement service requests from a plurality of access points;
determine a plurality of similar generic advertisement service requests from the received plurality of generic advertisement service requests, based on a common medium access control address and a common dialog token;
transmit a single network query request corresponding to the plurality of similar generic advertisement service requests, to a generic advertisement service application server;
receive a generic advertisement service response from the generic advertisement service application server; and
transmit to at least one of the plurality of access points the generic advertisement service response and instructions to at least transmit the generic advertisement service response with an indication that all generic advertisement service responses are duplicates.

25. The apparatus of claim 24, wherein the instructions are to perform at least one of:
transmit a probe response with an indication that a separate single wireless generic advertisement service response is transmitted from single access point device;
transmit a combined wireless probe response and the generic advertisement service response with an indication that all generic advertisement service responses are duplicates; or
transmit a wireless probe response with an indication of a separate generic advertisement service response, and transmit the separate generic advertisement service response with an indication that all other responding access point devices have the same generic advertisement service response information.

26. The apparatus of claim 24, wherein the apparatus is an access point in a same network as the plurality of access points.

27. A computer program product comprising computer executable program code recorded on a computer readable, non-transitory storage medium, the computer executable program code, when executed by a computer processor, comprising:
code for broadcasting a wireless generic advertisement service request to a plurality of wireless devices, including an indication that a single response is sufficient; and
code for receiving one or more wireless generic advertisement service responses from only one or more of a plurality of wireless devices in response to the indication that a single response is sufficient.

28. A computer program product comprising computer executable program code recorded on a computer readable, non-transitory storage medium, the computer executable program code, when executed by a computer processor, comprising:
code for receiving a wireless generic advertisement service request to a broadcast address, including an indication that a single response is sufficient;
code for transmitting the generic advertisement service request to a server, if a single wireless generic advertisement service response is required; and
code for receiving a generic advertisement service response and instructions from the server to at least transmit the generic advertisement service response with an indication that all generic advertisement service responses are duplicates.

29. A computer program product comprising computer executable program code recorded on a computer readable, non-transitory storage medium, the computer executable program code, when executed by a computer processor, comprising:
code for receiving a plurality of generic advertisement service requests from a plurality of access points;
code for determining a plurality of similar generic advertisement service requests from the received plurality of generic advertisement service requests, based on a common medium access control address and a common dialog token;
code for transmitting a single network query request corresponding to the plurality of similar generic advertisement service requests, to a generic advertisement service application server;
code for receiving a generic advertisement service response from the generic advertisement service application server; and
code for transmitting to at least one of the plurality of access points the generic advertisement service response and instructions to at least transmit the generic advertisement service response with an indication that all generic advertisement service responses are duplicates.

30. The method of claim 1, wherein the indication that a single response is sufficient is provided by a mandated requirement of a communications standard under which the wireless generic advertisement service request is broadcast, the communications standard requiring a single response to be sufficient.

31. The method of claim 1, wherein the wireless generic advertisement service request includes response criteria parameters to control devices that respond to the request.

32. The method of claim 9, further comprising:
wherein the wireless generic advertisement service request is a combined Probe Request and GAS Query initiation request;
transmitting to a sender of the wireless generic advertisement service request, a Probe Response in response to the Probe Request;
transmitting the GAS Query initiation request to the server,
receiving a GAS Query response from the server; and
transmitting the GAS Query response to the sender of the wireless generic advertisement service request if the transmitted Probe Response was a first occurring transmission of a Probe Response.

33. The method of claim 32, wherein the Probe Response includes an indication that a GAS Response will follow.

34. The method of claim 9, further comprising:
wherein the wireless generic advertisement service request is a combined Probe Request and GAS Query initiation request;
transmitting to a sender of the wireless generic advertisement service request, a Probe Response in response to the Probe Request;
transmitting the GAS Query initiation request to the server,
receiving a GAS Query response from the server; and
deleting the GAS Query response if the transmitted Probe Response was not a first occurring transmission of a Probe Response.

35. The method of claim 11, wherein the instructions are to transmit a separate single wireless generic advertisement service response by a single access point device that is specified by the mobile wireless device in the wireless generic advertisement service request.

36. The method of claim 11, wherein the single network query request to the generic advertisement service application server, includes information for instructing an access point to set information fields in a generic advertisement service response.

37. The method of claim 1, further comprising:
receiving multiple wireless generic advertisement service responses that indicate a subset of GAS parameters that are needed for link setup that are the same for a plurality of access points.
